(19) United States
(12) Patent Application Publication
(10) Pub. No.: US 2011/0171871 A1
(43) Pub. Date: Jul. 14, 2011

(54) METHOD FOR PRODUCING PLASMA DISPLAY PANEL

(76) Inventors: Hiroyoshi Sekiguchi, Osaka (JP); Yasuhiro Asaida, Kyoto (JP); Takayuki Ashida, Osaka (JP); Tomohiro Okumura, Osaka (JP)

(21) Appl. No.: 13/004,361

(22) Filed: Jan. 11, 2011

(30) Foreign Application Priority Data
Jan. 13, 2010 (JP) P 2010-004853

(51) Int. Cl. H01J 9/20

(52) U.S. Cl. 445/25

(57) ABSTRACT

A method for producing a plasma display panel includes: (i) providing a front panel and a rear panel, the front panel being a panel wherein an electrode A, a dielectric layer A and a protective layer are formed on a substrate A, and the rear panel being a panel wherein an electrode B, a dielectric layer B, a barrier rib and a phosphor layer are formed on a substrate B; (ii) supplying a glass frit material onto a peripheral region of the substrate A or B to form a glass frit sealing member; (iii) opposing the front and rear panels with each other such that the glass frit sealing member is interposed therebetween; and (iv) heating the opposed front and rear panels to reach a softening point of the glass frit sealing member or a higher temperature than the softening point, while supplying a cleaning gas into a space formed between the opposed front and rear panels. Prior to the heating of step (iv), a gas is introduced into a space formed between the opposed front and rear panels, or a gas is exhausted from a space formed between the opposed front and rear panels.

### FIELD OF THE INVENTION

The present invention relates to a method for producing a plasma display panel which can be used for display devices.

### BACKGROUND OF THE INVENTION

A plasma display panel (hereinafter also referred to as “PDP”) has capabilities of high definition reproduction of pictures and larger screen, and thus has been commercialized as 100-inch class television sets. In recent years, it has been attempted to apply the PDP to high definition television sets with twice or more scan lines as those of the conventional NTSC TV format. Furthermore, there have been increasingly required for the PDP to have decreased power consumption for addressing the energy issue and to have lead-free material for meeting the environmental requirement.

The PDP is basically composed of a front panel and a rear panel. The front panel is disposed at the front such as it faces the viewer. Such front panel is generally provided with a glass substrate, display electrodes (each of which comprises a transparent electrode and a bus electrode), a dielectric layer and a protective layer. Specifically, (i) on one of principal surfaces of the glass substrate (e.g. sodium borosilicate glass substrate which is produced by a floating process or the like), the display electrodes are formed in a form of stripes; (ii) the dielectric layer is formed on the principal surface of the glass substrate so as to cover the display electrodes and serve as a capacitor; and (iii) the protective layer (e.g. MgO layer) is formed on the dielectric layer so as to protect the dielectric layer.

The rear panel is generally provided with a glass substrate, address electrodes, a dielectric layer, barrier ribs and phosphor layers (i.e. red (R), green (G) and blue (B) fluorescent layers). Specifically, (i) on one of principal surfaces of the glass substrate, the address electrodes are formed in a form of stripes; (ii) the dielectric layer is formed as a base dielectric layer on the principal surface of the glass substrate so as to cover the address electrodes; (iii) a plurality of barrier ribs (i.e. barrier ribs) are formed on the dielectric layer at equal intervals; and (iv) the phosphor layers are formed on the dielectric layer such that each of them is located between the adjacent barrier ribs.

The front panel and the rear panel are opposed to each other so that their electrodes are faced each other. The opposed front and rear panels are sealed together to form an airtight discharge space that is divided by the barrier ribs. The discharge space is filled with a discharge gas such as neon (Ne)-xenon (Xe) gas at a pressure of 400 Torr to 600 Torr. In operation of the PDP, ultraviolet rays are generated in the discharge cell upon selectively applying a voltage (i.e. voltage of picture signal), and thereby the phosphor layers capable of emitting different visible lights are excited. As a result, the excited phosphor layers respectively emit lights in red, green and blue colors, which will lead to an achievement of a full-color display.

The PDP is ordinarily operated by such a method that sets an initialization period during which charges on the wall are adjusted into a state that allows easy writing, a writing period during which writing electric discharge is carried out in accordance to the input picture signal, and a sustain period during which the pictures are displayed by causing sustain electric discharge in the discharge space wherein the writing operation has been done. Thus, the PDP displays gradation pictures by repeating a period (sub-field) that consists of the periods described above a plurality of times within a period (one field) that corresponds to one frame of picture.

In the PDP, the protective layer of the front panel generally serves to protect the dielectric layer from ion bombardment caused by electric discharge and also serves to release primary electrons for generating an address electric discharge. The protecting of the dielectric layer from ion bombardment is important in terms of preventing the discharge voltage from rising. Whereas, the releasing of the primary electrons for generating the address electric discharge is important in terms of preventing a failure of the address electric discharge, the failure being a factor for causing a blinking of the picture.

There are some attempts to increase the number of primary electrons released from the protective layer, and thereby suppressing the blinking of the picture. For example, some impurity is added to the MgO protective layer, or MgO particles are formed on the MgO protective layer (see, for example, Japanese Patent Kokai Publication No. 2002-260535, Japanese Patent Kokai Publication No. 11-339665, Japanese Patent Kokai Publication No. 2006-59779, Japanese Patent Kokai Publication No. 8-236028 and Japanese Patent Kokai Publication No. 10-334809).

### SUMMARY OF THE INVENTION

### Problems to be Solved by the Invention

In a recent trend of television sets toward a higher definition of picture display, there is demand in the market for full HD (high definition) PDP (e.g. with progressive display with 1920 by 1080 pixels) with low cost, low power consumption and high brightness. The electron releasing characteristic of the protective layer determines a picture quality of the PDP, and thus it is very important to control such electron releasing characteristic.

In order to display pictures with high definition, it is generally necessary to decrease the width of the pulse that is applied to the address electrodes during the writing period of the sub-field, since the number of pixels for writing increases despite the constant length of one field. However, there is a time lag called “delay in electric discharge” before electric discharge occurs in the discharge space after the rise of the voltage pulse, and thus a narrower pulse width results in lower probability of electric discharge being completed within the writing period. As a result, a lighting failure may be occurred, which leads to a deterioration of picture quality (e.g. a display blinking).

In order to achieve a higher definition and a lower power consumption of the PDP, it is necessary to not only suppress the discharge voltage from becoming higher but also suppress the lighting failure from being occurred in light of an improved picture quality.

Under the above circumstances, the present invention has been created. In other words, an object of the present invention is to provide a method for producing a PDP with a higher brightness display and a low voltage driving.

### Means for Solving the Problems

In order to achieve the above object, the present invention provides a method for producing a plasma display panel, the method comprising:

(i) providing a front panel and a rear panel, the front panel being a panel wherein an electrode A, a dielectric layer A and a protective layer are formed on a substrate A, and the rear panel being a panel wherein an electrode B, a dielectric layer B, a barrier rib and a phosphor layer are formed on a substrate B;

(ii) supplying a glass frit material onto a peripheral region of the substrate A or B to form a glass frit sealing member;

(iii) opposing the front and rear panels with each other such that the glass frit sealing member is interposed therebetween; and

(iv) heating the opposed front and rear panels to reach a softening point of the glass frit sealing member or a higher temperature than the softening point and thereby causing the front and rear panels to be sealed, while supplying a cleaning gas into a space formed between the opposed front and rear panels until the point in time when the softening point (or a higher temperature than the softening point) of the glass frit sealing member is reached from an initiation of the heating of the panels, wherein

prior to the initiation of the heating of the step (iv), a gas is introduced into the space formed between the opposed front and rear panels, or a gas is exhausted from the space formed between the opposed front and rear panels, and thereby a difference in pressure between before and after the gas introduction or the gas exhaustion is determined.

The production method of the present invention is characterized in that, prior to the heat treatment of the step (iv), “gas introduction” or “gas exhaustion” is performed, and thereby a difference in pressure between before and after the gas introduction or the gas exhaustion is determined (see FIG. 1 and FIG. 2). By determining the difference in pressure, it is possible to grasp or know a connected state (or attached state) of a gas introduction line and/or gas exhaustion line, and also an assembled state of them with the “opposed front and rear panels” (i.e. the assembled state of “gas introduction line” and “opposed front and rear panels” or the assembled state of “gas exhaustion line” and “opposed front and rear panels”). The grasp of the “connected state” and “assembled state” allows to readjust them if necessary, and thus the subsequent “cleaning process” can be suitably performed.

If the gas introduction line and/or gas exhaustion line is in an insufficient connected state, or they are in an insufficient assembled state with the “opposed front and rear panels”, the cleaning gas are unlikely to sufficiently flow to the “space formed between the opposed front and rear panels” in the step (iv). In this regard, the present invention can figure out the above insufficient state in advance by the “difference in pressure” and thus can avoid an adverse effect attributable thereto.

As used in the present description, the phrase “difference in pressure is determined” means that a pressure difference “Pb−Pa” between “pressure Pa before the introduction of gas” and “pressure Pb after the introduction of gas” is determined upon the introduction of the gas. More specifically, such phrase substantially means that a pressure difference inside a piping (inside a line) between before and after the gas introduction is determined upon performing the gas introduction through a piping (line) being in fluid communication with an inner space of the “opposed front and rear panels”. For example, a value of a pressure gauge provided to a gas introduction piping (gas introduction line) which is in fluid communication with the inner space of the “opposed front and rear panels” is obtained before and after the gas introduction.

Similarly, in the case of gas exhaustion, the phrase “difference in pressure is determined” means that a pressure difference “Pd−Pc” between “pressure Pc before the exhaustion of gas” and “pressure Pd after the exhaustion of gas” is determined. More specifically, it substantially means that a pressure difference inside a piping (inside a line) between before and after the gas exhaustion is determined upon performing the gas exhaustion through a piping (line) provided in fluid communication with an inner space of the “opposed front and rear panels”. For example, a value of a pressure gauge provided to a gas exhaustion piping (gas exhaustion line) which is in fluid communication with the inner space of the “opposed front and rear panels” is obtained before and after the gas exhaustion.

As used in this specification or claims, the term “cleaning gas” may be interpreted as “purifying gas” or “purification gas”. Similarly, the term “cleaning process” may be interpreted as “purifying process” or “purification process”, and the term “clean” may also be interpreted as “purify”.

In one preferred embodiment, upon introducing the gas into the space formed between the opposed front and rear panels prior to the heating of the step (iv), a line for introducing a discharge gas for the plasma display panel is used as at least a portion of the gas introduction line. In other words, a gas introduction is performed for the measurement of the pressure difference by using a chip tube which is provided with respect to a through hole of the rear panel by means of a frit ring. In this case, it is possible to make use of a pressure gauge provided in a chip tube or a piping connected thereto to measure the pressure difference. Similarly, upon introducing the gas into the space formed between the opposed front and rear panels prior to the heating of the panels, an exhausting line (i.e. a line used for exhausting an internal gas of the panel after a sealing treatment) and a pressure gauge provided therein may be used as at least a portion of the gas introduction line.

In addition to the embodiment wherein “gas introduction” or “gas exhaustion” is performed prior to the initiation of the heat treatment of the step (iv), the present invention makes it possible to introduce a gas into the space formed between the opposed front and rear panels until the point in time when the softening point of the glass frit sealing member is reached after the initiation of a heat treatment of the panels, and thereby a difference in pressure between before and after such gas introduction can be additionally determined. Similarly, in addition to the embodiment wherein “gas introduction” or “gas exhaustion” is performed prior to the initiation of the heat treatment of the step (iv), the present invention makes it possible to exhaust a gas from the space formed between the opposed front and rear panels until the point in time when the softening point of the glass frit sealing member is reached after the initiation of the heat treatment of the panels, and thereby a difference in pressure between before and after the gas exhaustion can be additionally determined. Theses additional determination can detect a failure, if any, of the assembled or moutend gas introduction line and/or gas exhaustion line after the heat treatment, and thereby the panels associated with such failure can be removed in advance from a PDP production line.

In the present invention, the protective layer preferably comprises at least one kind of metal oxide selected from the group consisting of magnesium oxide, calcium oxide, strontium oxide and barium oxide, in which case the cleaning gas used in the step (iv) is preferably a gas which is inactive with respect to the protective layer (namely, the cleaning gas is preferably a non-reactive gas or inert gas). For example, the cleaning gas is at least one kind of gas selected from the group consisting of a nitrogen gas, a noble gas and a dry air. In such case, a denatured layer, which may be formed in the protective layer of the front panel, can be effectively removed by the flow of the cleaning gas. As used in this specification, the phrase like “removal of denatured layer” substantially means that the adsorbed impurities are removed from the protective layer, or that a hydroxylated or carbonated portion of the protective layer is restored into the original oxide.

In one preferred embodiment, the cleaning gas can be additionally used as the gas for determining the difference in pressure between before and after the gas introduction. In other words, at least one kind of gas selected from the group consisting of a nitrogen gas, a noble gas and a dry air can be used as an inspection gas to detect a failure of the assembled or connected gas introduction line and/or gas exhaustion line.

The production method of the present invention further comprises a step (v) of performing a temperature falling so as to reach a temperature which is lower than the softening point of the glass frit sealing member; a step (vi) of exhausting the inner gas of the front and rear panels after the completion of the sealing due to the temperature falling; and a subsequent step of introducing and filling a discharge gas into the inner space provided between the front and rear panels. As for carrying out of the steps (v) and (vi), the exhaustion and filling can be performed via the through hole provided in the front panel or rear panel.

### Effects of the Invention

In accordance with the present invention, the adverse effect, which is attributable to the specific component of the protective layer for desired panel characteristics, is avoided or eliminated by the flow of the introduced cleaning gas. In other words, according to the method of the present invention, the flow of the cleaning gas can suppress an unnecessary reaction between the protective layer and the impurity gas upon the PDP producing process. Moreover even when a denatured layer has been formed in the surface region of the protective layer due to the above unnecessary reaction, the denatured layer can be easily removed by the flow of the cleaning gas. As a result, the present invention makes it possible to produce PDP with a higher brightness display and a lower voltage driving.

Particularly the production method of the present invention makes it possible to take steps in advance so as to sufficiently or surely supply the cleaning gas into the space formed between the opposed front and rear panels, and thereby the “suppression of the unnecessary reaction” and “removal of the denatured layer” can be more effectively carried out (for example, the whole of the protective layer can be more evenly cleaned). In other words, prior to the heat treatment (i.e. heat treatment being performed for the sealing process while performing the cleaning process), the difference in pressure between before and after the gas introduction, or before and after the gas exhaustion is determined, and thereby the connected state of the gas introduction line and gas exhaustion line and/or the assembled state with the “opposed front and rear panels” are recognized in advance. Therefore, when the connected state or assembled state is insufficient, it is possible to reassemble, reconnect or reattach them, and thus the subsequent panel cleaning can be suitably carried out. This means that the present invention can preliminarily remove an insufficient connected state or assembled state of the gas introduction line or gas exhaustion line (the insufficient connected state or assembled state being a factor for causing a leakage of the cleaning gas), and thereby a sufficient cleaning is achieved with the desired panels which make it possible to carry out a sufficient supply of the cleaning gas.

Since the cleaning process can be suitably carried out, the protective layer can be formed from a specific component in light of favorability for the panel characteristics. The phrase “specific component in light of favorability for the panel characteristics” used herein refers to a metal oxide comprising at least two oxides selected from among magnesium oxide, calcium oxide, strontium oxide and barium oxide, the metal oxide having a peak diffraction angle between the minimum diffraction angle and the maximum diffraction angle which are selected among the diffraction angles given by respective ones of at least two oxides constituting the metal oxide with respect to a specific orientation plane of X-ray diffraction analysis of the metal oxide. Use of such metal oxide for the protective layer can decrease the electric discharge starting voltage and decrease the delay in electric discharge, thus resulting in a stable electric discharge. It should be noted that such favorable metal oxide is highly reactive with water and impurity gas (e.g. carbon dioxide). Namely, the use of such metal oxide as a components of the protective layer may, in general, cause the protective layer to react with water and carbon dioxide, thus resulting in a deterioration of the electric discharge characteristic. In this regard, the present invention can avoid such undesirable reaction since the cleaning process is suitably carried out as described above, and thereby the positive use of the favorable metal oxide is promoted.

### BRIEF DESCRIPTION OF THE DRAWINGS

FIG. 1 is a view schematically showing a concept of the present invention (FIG. 1(a) shows an embodiment in which a pressure difference between before and after gas introduction is determined, whereas FIG. 1(b) shows an embodiment in which a pressure difference between before and after gas exhaustion is determined).

FIG. 2 is a perspective sectional view schematically showing a concept of the present invention.

FIG. 3 is a diagram schematically showing a constitution of PDP (FIG. 3(a) is a perspective view schematically showing a structure of PDP, and FIG. 3(b) is a sectional view schematically showing a front panel of PDP).

FIG. 4 is a diagram schematically showing an embodiment wherein a plurality of gas supply openings are provided.

FIG. 5 is a view schematically showing a form of barrier ribs.

FIG. 6 is a sectional view schematically showing an embodiment of a glass frit sealing portion and barrier ribs between the front panel and the rear panel.

FIG. 7 is a diagram schematically showing an embodiment after a sealing treatment.

FIG. 8 is a diagram showing the result of X-ray diffraction analysis with respect to the base film of the PDP protective layer.

FIG. 9 is a diagram showing the result of X-ray diffraction analysis with respect to the base film of the PDP protective layer (another component).

FIG. 10 is an enlarged diagram showing aggregated particles of the PDP protective layer.

FIG. 11 is a diagram showing a relationship between the delay in discharge of the PDP and calcium (Ca) concentration in the protective layer.

FIG. 12 is a diagram showing the outcomes of study as to the electron releasing performance and electric charge retaining performance of the PDP.

FIG. 13 is a diagram showing a relationship between the crystal particle size used in the PDP and the electron releasing characteristic.

FIG. 14 is a flowchart of operations associated with the first embodiment of a method for producing a plasma display panel according to the present invention.

FIG. 15 is a process time chart in the first embodiment of the present invention.

FIG. 16 is a schematic view of a device used in the first embodiment of the present invention.

FIG. 17 is a graph for explaining about “Good”/“Poor” based on a pressure difference between before and after gas introduction.

FIG. 18 is a flow chart in the case of readjusting a connected state and an assembled state of the associated parts or components of PDP production.

FIG. 19 is a flowchart of operations associated with the second embodiment of a method for producing a plasma display panel according to the present invention.

FIG. 20 is a process time chart in the second embodiment of the present invention.

FIG. 21 is a flowchart of operations associated with the third embodiment of a method for producing a plasma display panel according to the present invention.

FIG. 22 is a process time chart in the third embodiment of the present invention.

FIG. 23 is a graph for explaining about “Good”/“Poor” based on a pressure difference between before and after gas exhaustion.

FIG. 24 is a diagram for explaining about the fourth embodiment of the present invention.

FIG. 25 is a diagram for explaining about the fifth embodiment of the present invention.

FIG. 26 is a diagram schematically showing an embodiment wherein a cleaning gas is introduced via grooves provided in a glass frit sealing member which has annular form.

FIG. 27 is a diagram showing an aspect (FIG. 27(a)) of Examples and the result thereof (FIG. 27(b)).

### DESCRIPTION OF REFERENCE NUMERALS

1 . . . Front panel
2 . . . Rear panel
10 . . . Substrate A of front panel
11 . . . Electrode A of front panel (Display electrode)
12 . . . Scan electrode
12a . . . Transparent electrode
12b . . . Bus electrode
13 . . . Sustain electrode
13a . . . Transparent electrode
13b . . . Bus electrode
14 . . . Black stripe (Light shielding layer)
15 . . . Dielectric layer A of front panel
16 . . . Protective layer
16a . . . Base film of protective layer
16b . . . Crystal particles disposed on base film of protective layer
16b′ . . . Aggregated particles composed of a plurality of crystal particles
20 . . . Substrate B of rear panel
21 . . . Electrode B of rear panel (Address electrode)
22 . . . Dielectric layer B of rear panel
23 . . . Barrier rib (Partition wall)
23a . . . Barrier rib extending along longer side
23b . . . Barrier rib extending along shorter side
25 . . . Phosphor layer (Fluorescent layer)
29 . . . Through hole (Gas supply opening/gas introduction opening)
30 . . . Discharge space
32 . . . Discharge cell
55 . . . Chip tube/Tip tube (Exhaust tube)
56 . . . Frit ring
57 . . . Chuck head
68 . . . Piping
70 . . . Clip
86 . . . Glass frit sealing member
86′ . . . Glass frit sealing member for blocking gas supply opening
86″ . . . Glass frit sealing member after sealing treatment
92b . . . gas supply opening (plurality of gas supply openings)
101 . . . Aligned panels
104 . . . Gas piping
105 . . . Pressure gauge
105′ . . . Pressure gauge for discharge gas introduction/pressure gauge for vacuum exhausting
110 . . . Foreign matters (e.g. dusts)
111 . . . Piping for discharge gas introduction
112 . . . Piping for exhausting

### DETAILED DESCRIPTION OF THE PREFERRED EMBODIMENT

With reference to the accompanying drawings, a method for producing a plasma display panel according to the present invention will be described in detail. Various components or elements are shown schematically in the drawings with dimensional proportions and appearances that are not necessarily real, which are merely for the purpose of making it easy to understand the present invention.

### [Construction of Plasma Display Panel]

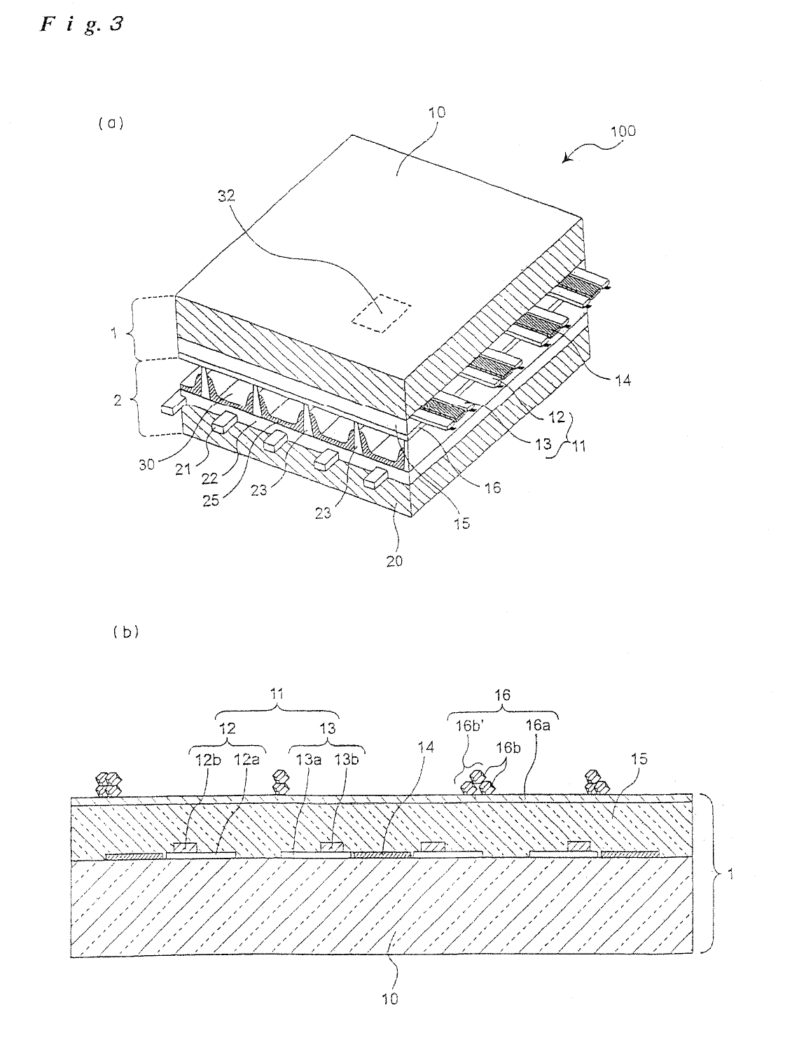

First, a plasma display panel, which can be finally obtained by the method of the present invention, is described below. FIG. 3(a) schematically shows a perspective and sectional view of the construction of PDP. FIG. 3(b) schematically shows a sectional view of the front panel of the PDP.

As shown in FIG. 3(a), the PDP (100) of the present invention comprises a front panel (1) and a rear panel (2) opposed to each other. The front panel (1) is generally provided with a substrate A (10), electrodes A (11), a dielectric layer A (15) and a protective layer (16). The rear panel (2) is generally provided with a substrate B (20), electrodes B (21), a dielectric layer B (22), barrier ribs (23) and phosphor layers (25).

As for the front panel (1), (i) on one of principal surfaces of the substrate A (10), the electrodes A (11) are formed in a form of stripes; (ii) the dielectric layer A (15) is formed on the principal surface of the substrate A (10) so as to cover the electrodes A (11); and (iii) the protective layer (16) is formed on the dielectric layer A (15) so as to protect the dielectric layer A (15). As for the rear panel (2), (i) on one of principal surfaces of the substrate B (20), the electrodes B (21) are formed in a form of stripes; (ii) the dielectric layer B (22) is formed on the principal surface of the substrate B (20) so as to cover the electrodes B (21); (iii) a plurality of barrier ribs (23) are formed on the dielectric layer B (22) at equal intervals; and (iv) the phosphor layers (25) are formed on the dielectric layer B (22) such that each of them is located between the adjacent barrier ribs (23). As illustrated, the front panel (1) and the rear panel (2) are opposed to each other. The opposed front and rear panels are sealed along their peripheries by a sealing member (not shown). As the sealing member, a material consisting mainly of a glass frit with a low melting point may be used. Between the front panel (1) and the rear panel (2), there is formed a discharge space (30) filled with a discharge gas (helium, neon, xenon or the like) under a pressure preferably ranging from 20 kPa to 80 kPa.

The PDP (100) of the present invention will be described below in much more detail. As described above, the front panel (1) of the PDP (100) according to the present invention comprises the substrate A (10), the electrodes A (11), the dielectric layer A (15) and the protective layer (16). The substrate A (10) is a transparent substrate with an electrical insulating property. The thickness of the substrate A (10) may be in the range of from about 1.0 mm to about 3 mm. The substrate A (10) may be a float glass substrate produced by a floating process. The substrate A (10) may also be a soda lime glass substrate or a borosilicate glass substrate. A plurality of electrodes A (11) are formed in a pattern of parallel stripes on the substrate A (10). It is preferred that the electrode A (11) is a display electrode which is composed of a scan electrode (12) and a sustain electrode (13). Each of the scan electrode (12) and the sustain electrode (13) is composed of a transparent electrode (12a, 13a) and a bus electrode (12b, 13b) as shown in FIG. 3(b). The transparent electrode (12a, 13a) may be an electrically conductive film made of indium oxide (ITO) or tin oxide (SnO₂) in which case the visible light generated from the phosphor layer can go through the film. The bus electrode (12b, 13b) is formed on the transparent electrode (12a, 13a), and may be mainly made of silver so that it serves to reduce a resistance of the display electrode and give an electrical conductivity in the longitudinal direction for the transparent electrode. Thickness of the transparent electrodes (12a, 13a) is preferably in the range of from about 50 nm to about 500 nm whereas thickness of the bus electrodes (12b, 13b) is preferably in the range of from about 1 μm to about 20 μm. As shown in FIG. 3(a), black stripes (14) (i.e. light shielding layer) may also be additionally formed on the substrate A (10).

The dielectric layer A (15) is provided to cover the electrodes A (11) on the surface of the substrate A (10). The dielectric layer A (15) may be a glass film, for example an oxide film (e.g. silicon oxide film). Such oxide film can be formed by applying a dielectric material paste consisting mainly of a glass component and a vehicle component (i.e. component including a binder resin and an organic solvent), followed by heating the dielectric material paste. On the dielectric layer A (15), there is formed the protective layer (16) whose thickness is for example from about 0.5 μm to about 1.5 μm. The protective layer (16) may be made of magnesium oxide (MgO), and serves to protect the dielectric layer A (15) from a discharge impact (more specifically, from the impact of ion bombardment attributable to the plasma).

As described above, the rear panel (2) of the PDP according to the present invention comprises the substrate B (20), the electrodes B (21), the dielectric layer B (22), the barrier ribs (23) and the phosphor layers (25). The substrate B (20) is preferably a transparent substrate with an electrical insulating property. The thickness of the substrate B (20) may be in the range of from about 1.0 mm to about 3 mm. The substrate B (20) may be a float glass substrate produced by a floating process. The substrate B (20) may also be a soda lime glass substrate or a borosilicate glass substrate. Furthermore, the substrate B (20k may also be a substrate made of various ceramic materials. A plurality of the electrodes B (21) are formed in a pattern of parallel stripes on the substrate B (20). For example, the electrode B (21) is an address electrode or a data electrode (whose thickness is for example about 1 μm to about 10 μm). The electrodes B (21) serve to cause the discharge to occur selectively in particular discharge cells. The electrodes B (21) can be formed from an electrically conductive paste including silver as a main component.

The dielectric layer B (22) is provided to cover the electrodes B (21) on the surface of the substrate B (20). The dielectric layer B (22) is generally referred to as a base dielectric layer. The dielectric layer B (22) may be a glass film, for example an oxide film (e.g. silicon oxide film). Such oxide film can be formed by applying a dielectric material paste consisting mainly of a glass component and a vehicle component (i.e. component including a binder resin and an organic solvent), followed by heating the dielectric material paste. Thickness of the dielectric layer B (22) is preferably in the range of from about 5 μm to about 50 μm. On the dielectric layer B (22), there is formed the phosphor layers (25) whose thickness is for example from about 5 μm to about 20 μm. The phosphor layers (25) serve to convert the ultraviolet ray emitted due to the discharge into visual light ray. The three kinds of the phosphor layer constitute a basic unit wherein three kind of fluorescent material layers, each of which is separated from each other by the barrier ribs (23), are respectively capable of emitting red, green and blue lights. The barrier ribs (23) are provided in a form of stripes or in two pairs of perpendicularly intersecting parallel lines on the dielectric layer B (22). The barrier ribs (23) serve to divide the discharge space into cells, each of which is allocated to one of the address electrodes (21). The barrier ribs (23) can be made from a paste containing of a glass power, a vehicle component, a filler, etc.

In the PDP (100), the front panel (1) and the rear panel (2) are opposed to each other such that the display electrode (11) of the front panel (1) and the address electrode (21) of the rear panel (2) perpendicularly intersect with each other. Between the front panel (1) and the rear panel (2), there is formed a discharge space (30) filled with a discharge gas. With such a construction of the PDP (100), the discharge space (30) is divided by the barrier ribs. Each of the divided discharge space (30), at which the display electrode (11) and the address electrode (21) intersect with each other, serves as a discharge cell (32). The discharge cells (32) arranged in a matrix form give an image display region. The discharge gas is caused to discharge by applying a picture signal voltage selectively to the display electrodes (11) from an external drive circuit. The ultraviolet ray generated due to the discharge of the discharge gas can excite the phosphor layers so as to emit visible lights of red, green and blue colors therefrom, which will lead to an achievement of a display of color images or pictures.

### [General Method for Production of PDP]

Next, a typical production of the PDP will be briefly described. In this specification, unless otherwise mentioned, raw materials (i.e. paste material) of the constituent members or parts may be the same as those used in the conventional PDP production.

The typical production of the PDP (100) comprises a step for forming the front panel (1) and a step for forming the rear panel (2). As for the step for forming the front panel (1), not only the display electrode (11) composed of the scan electrode (12) and the sustain electrode (13) but also and the light shielding layer (14) is firstly formed on the glass substrate A (10). In the forming of each of the scan electrode (12) and the sustain electrode (13), a transparent electrode (12a, 13a) and a bus electrode (12b, 13b) can be formed through a patterning process such as a photolithography wherein an exposure and a developing are carried out. The transparent electrode (12a, 13a) can be formed by a thin film process. The bus electrode (12b, 13b) can be formed by drying a silver (Ag)-containing paste at a temperature of about 100 to 200° C., followed by a calcining treatment thereof at a temperature of about 400 to 600° C. The light shielding layer (14) can also be formed in a similar way. Specifically, a light shielding layer precursor can be formed in a desired form by a screen printing process wherein a black pigment-containing paste is printed, or by a photolithography process wherein a black pigment-containing paste is applied over the substrate followed by exposure and developing thereof. The resulting light shielding layer precursor is finally calcined to form the light shielding layer therefrom. After the formation of the display electrode (11) and the light shielding layer (14), the dielectric layer A (15) is formed. Specifically, a layer of dielectric material paste is firstly formed on the substrate A (10) so as to cover the scan electrodes (12), sustain electrodes (13) and the light shielding layer (14). This formation of the paste layer can be performed by applying a paste of dielectric material consisting mainly of a glass component (a material including SiO₂, B₂O₃, etc.) and a vehicle component with a die coating or printing process. The dielectric material paste that has been applied is left to stand for a predetermined period of time, so that the surface of the dielectric material paste becomes flat. Then the layer of dielectric material paste is calcined to form the dielectric layer A (15) therefrom. After the formation of the dielectric layer A (15), the protective layer (16) is formed on the dielectric layer A (15). In a general sense, the protective layer (16) can be formed by a vacuum deposition process, a CVD process, a sputtering process or the like.

By performing the above steps or operations as described above, the front panel (1) of the PDP can be finally obtained wherein the electrodes A (the scan electrodes (12) and the sustain electrodes (13)), the dielectric layer A (15) and the protective layer (16) are formed on the substrate A (10).

The rear panel (2) is produced as follows. First, a precursor layer for address electrode is formed by screen printing a silver (Ag)-containing paste onto a substrate B (20) (i.e. glass substrate). Alternatively, the precursor layer can be formed by a photolithography process in which a metal film consisting of silver as a main component is formed over the entire surface of the substrate and is subjected to an exposure and development treatments. The resulting precursor layer is then calcined at a predetermined temperature (for example, about 400° C. to about 600° C.), and thereby the address electrodes (21) are formed. The address electrodes (21) may be formed by applying a photoresist onto a three-layered thin film of chromium/copper/chromium, followed by pattering it with a photolithography and wet etching process. Subsequent to the formation of the electrodes (21), a dielectric layer B (22) (i.e. so-called “base dielectric layer”) is formed over the substrate B (20) so as to cover the address electrodes (21). To this end, a dielectric material paste that mainly contains a glass component (e.g. a glass material made of SiO₂, B₂O₃, or the like) and a vehicle component is applied by a die coating process or the like, so that a dielectric paste layer is formed. The resulting dielectric paste layer is then calcined to form the dielectric layer B (22) therefrom. Subsequently, the barrier ribs (23) are formed at a predetermined pitch. To this end, a material paste for barrier rib is applied onto the dielectric layer B (22) and then patterned in a predetermined form to obtain a barrier rib material layer. The barrier rib material layer is then heated to form the barrier ribs therefrom. Specifically, a material paste containing a low melting point glass material, a vehicle component, filler and the like as the main components is applied by a die-coating process or a printing process, and then the applied material paste is dried at a temperature of from about 100° C. to 200° C. The dried material is subsequently patterned in a predetermined form by performance of a photolithography process wherein an exposure and a development thereof are carried out. The resulting patterned material is subsequently calcined at a temperature of from about 400° C. to 600° C., and thereby the barrier ribs are formed therefrom. Alternatively, the barrier ribs (23) can also be formed a sand blast process, etching process, casting process or the like. After the formation of the barrier ribs (23), the phosphor layer (25) is formed. To this end, a phosphor material paste is applied onto the dielectric layer B (22) provided between the adjacent barrier ribs (23), and subsequently the applied phosphor material paste is calcined. Specifically, the phosphor layer (25) is formed by applying a material paste containing a fluorescent powder, a vehicle component and the like as the main components by performance of a die coating, printing, dispensing or ink-jet process, followed by drying the applied paste at a temperature of about 100° C. By performing the above steps or operations as described above, the rear panel (2) of the PDP can be finally obtained wherein the electrodes B (the address electrodes (21)), the dielectric layer B (22), the barrier ribs (23) and the phosphor layer (25) as constituent members are formed on the substrate B (20).

The front panel (1) and the rear panel (2), each being provided with the predetermined constituent members, are disposed to oppose each other such that the display electrode (11) and the address electrode (21) perpendicularly intersect with each other. The front panel (1) and the rear panel (2) are then sealed with each other along their peripheries by the glass frit. After sealing, the space between the front panel (1) and the rear panel is filled with a discharge gas (e.g. helium, neon or xenon), resulting in a completion of the production of PDP (100).

### [Method of the Present Invention]

The present invention is characterized by the process up to the panel sealing following the formation of the front and rear panels, among the above production steps or operations of the PDP. For descriptive purpose, a particular embodiment of the present invention will be mainly explained wherein a gas is introduced into the space provided between the front and rear panels prior to the heating of the step (iv), and thereby a pressure difference before and after the gas introduction.

As for the production method of the present invention, a step (i) is firstly carried out. In other words, there is provided the front panel wherein the electrodes A, the dielectric layer A and the protective layer are formed on the substrate A, and also the rear panel wherein the electrodes B, the dielectric layer B, the barrier ribs and the phosphor layers are formed on the substrate B. The provision of the front panel and the rear panel is described above (see [General Method for Production of PDP]), and thus is omitted here to avoid repetition. It should be, however, noted that the protective layer is preferably formed from a metal oxide comprising at least two oxides selected from among magnesium oxide, calcium oxide, strontium oxide and barium oxide. It is particularly preferred in the present invention that such metal oxide has a peak diffraction angle between the minimum diffraction angle and the maximum diffraction angle which are selected among the diffraction angles given by the respective one of the oxide constituting the metal oxide with respect to a specific orientation plane of X-ray diffraction analysis of the metal oxide. Use of such metal oxide for the protective layer can decrease the electric discharge starting voltage of the panel and decrease the delay in electric discharge, thus resulting in a stable electric discharge. Such favorable metal oxide is highly reactive with water and impurity gas (e.g. carbon dioxide). Namely, the use of such metal oxide as a components of the protective layer may, in general, cause the protective layer to react with water and carbon dioxide, thus resulting in a deterioration of the electric discharge characteristic. In this regard, the present invention can avoid such undesirable reaction since the cleaning process is suitably carried out (as will be described later), and thereby the positive use of the favorable metal oxide is promoted.

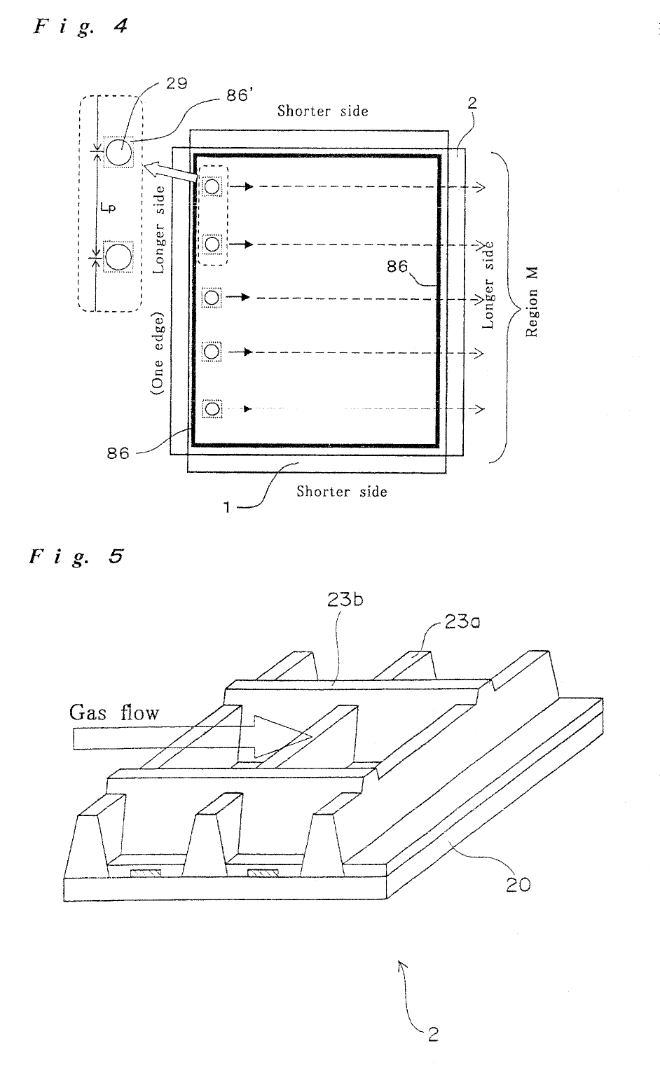

In a case where “cleaning” and/or “gas introduction for determination of pressure difference” is performed via an opening provided on the front panel or the rear panel in the step (iv), a gas supply opening (e.g. through hole) is formed on the front panel or the rear panel. In such a case, the gas supply opening may be formed by an appropriate process such as a drilling or laser machining process of the front or rear panel. In a case where the gas supply opening is provided in the rear panel, it is preferable to form the opening after the phosphor material paste is applied and dried. The gas supply opening may have any shape, form and size as long as it enables to introduce the gas therethrough into the space between the opposed front and rear panels (for example, the gas supply opening may be a circular opening with a diameter of about 1 to 20 mm). The number of the gas supply opening is not limited to one, and thus a plurality of the openings may be provided. In this case, pitch Lp of the gas supply openings (29) (see FIG. 4) is, for example, roughly in the range of from 50 to 500 mm while it may vary depending on the substrate size or the like. It is preferred that the plurality of the gas supply openings (29) are disposed along the longer side of an edge of the front panel (1) or rear panel (2) as shown in the drawing. The reason for this is that the gas supply through the longer side makes it possible to decrease the length of the gas streamline between the opposed front and rear panels than a case of the gas supply through the shorter side, which will lead to an achievement of more uniform removal of the denatured layer from the protective layer. Also as shown in FIG. 5, the barrier ribs are formed in a grating configuration wherein the barrier ribs (23a) extending along the longer side of the panel are lower in height than the barrier ribs (23b) extending along the shorter side of the panel. As a result, the introduction of the cleaning gas through the longer side enables the cleaning gas to flow more effectively between the front and rear panels. The word “plurality” regarding the phrase “plurality of the gas supply opening” substantially means a number of from 2 to 16.

Subsequent to the step (i) of the method of the present invention, the step (ii) is carried out. In other words, a glass frit material is applied onto a peripheral region of the substrate A or the substrate B so as to form an annular glass frit sealing member. More specifically, the annular glass frit sealing member is formed so that a continuous ring form thereof is formed around the overlapped area of the opposed front and rear panels. The glass frit sealing member thus formed serves to seal the peripheries of the front and rear panels in a sealing step that is subsequently performed. In the case where the gas supply opening is provided in the front or rear panel, the annular glass frit sealing member is formed outside the gas supply opening in the substrate of the front or rear panels. The glass frit material to be used is not particularly limited as long as it is used for the same purposes in the conventional production of the PDP. For example, a glass frit material consisting mainly of a glass material with a low melting point (e.g. lead oxide-boron oxide-silicon oxide based glass material or lead oxide-boron oxide-silicon oxide-zinc oxide-based glass material) may be used. The glass frit material may also contain a vehicle component in order to make it easier to apply. For example, the glass frit material may be prepared by adding a vehicle component consisting of “resin such as methyl cellulose, nitrocellulose” and “solvent such as α-terpineol or amyl acetate” to a sealing member made by uniformly mixing a PbO-based, P₂O₅—SnO-based or Bi₂O₃-based low melting point glass powder and a filler, followed by stirring them to form a paste thereof. The glass frit material preferably has a form of paste (with viscosity being in the range of from about 50 to 200 Pa·s at the normal temperature of about 23° C.), and an annular glass frit sealing member is formed through an application thereof. However, it is not limited to the glass frit material being in a form of paste. A solid glass frit material may also be used, in which case the annular glass frit sealing member can be formed by disposing the solid glass frit material. The annular glass frit sealing member, which is located along the peripheral region of the substrate A or the substrate B, preferably has a thickness of about 200 to 600 μm (for example, about 400 μm) and a width of about 3 to 10 mm.

The sealing member formed in the step (ii) may also be made of a material such as frit consisting mainly of bismuth oxide or vanadium oxide. The flit mainly consisting of bismuth oxide can be prepared, for example, by adding a filler consisting of oxides such as Al₂O₃, SiO₂ and cordierite to a Bi₂O₃—B₂O₃—RO-MO-based glass material (in which R represents any one of Ba, Sr, Ca and Mg, and also M represents any one of Cu, Sb and Fe)). The frit mainly consisting of vanadium oxide can be prepared by adding a filler consisting of oxide such as Al₂O₃, SiO₂ and cordierite to a V₂O₅—BaO—TeO—WO-based glass material.

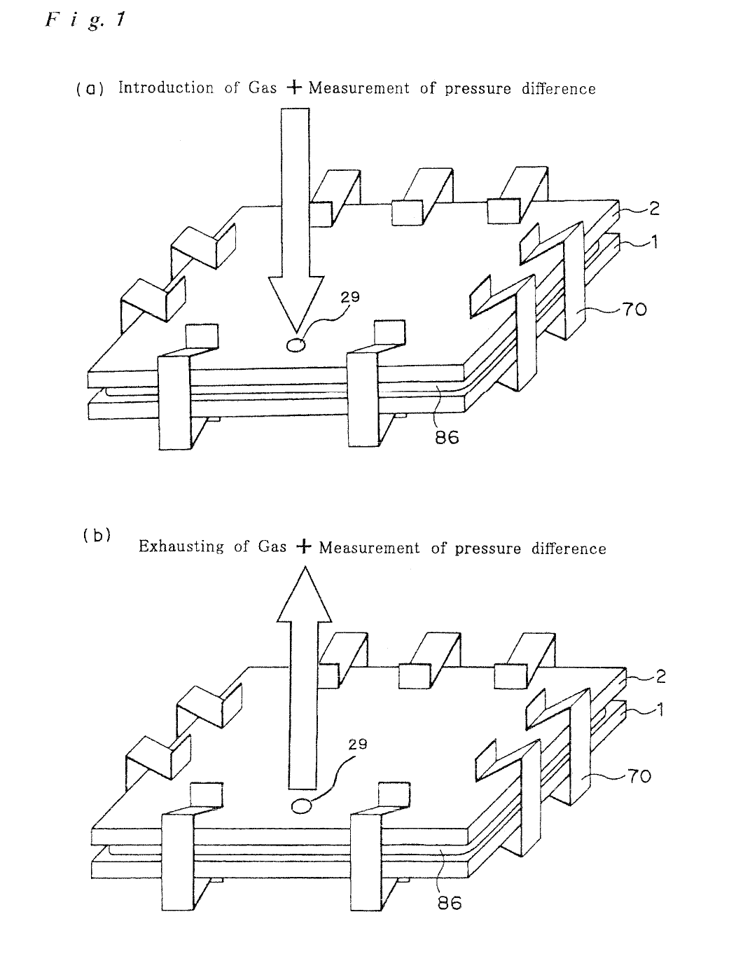

Subsequent to the step (ii) of the method of the present invention, the step (iii) is carried out. In other words, the front panel and the rear panel are disposed to oppose each other, so that the annular glass frit sealing member is located between the substrate A and the substrate B (see FIG. 1(a) or FIG. 1(b) for example). In other words, the front panel and the rear panel are disposed to oppose each other so that the protective layer and the phosphor layer face each other. The front panel and the rear panel are disposed substantially parallel to each other so that the display electrodes and the address electrodes cross at right angles. In the opposed front and rear panels, the annular glass frit sealing member (86) exists in the form of being interposed between the front panel (1) and the rear panel (2) as shown in FIG. 6. The opposed front panel (1) and the rear panel (2) may be held by a clip (70) or the like so as not to move thereafter (see FIG. 1(a) or FIG. 1(b)). The distance between the opposed front and rear panels (i.e., “gap size”) is preferably in the range of from 0.1 to 0.6 mm, more preferably from 0.3 to 0.6 mm, and still more preferably from 0.3 to 0.5 mm, while it may vary depending on the thickness of annular glass frit sealing member and other factors. While the rear panel (2) has the barrier ribs (23) therein, the annular glass frit sealing member (86) is higher than the barrier ribs (23) at the point in time before the sealing treatment is performed, and thus the top of the barrier rib (23) does not touch the front panel (1), as shown in FIG. 6. In other words, there are provided gaps inside the opposed panels, and therefore the cleaning gas is allowed to flow through the gaps.

Subsequent to the step (iii) of the method of the present invention, the step (iv) is carried out. In other words, a cleaning gas is supplied or blown into the space formed between the panels under such a condition that the panels are heated for “sealing” and/or “cleaning”. The cleaning gas can be supplied via the “gas supply opening”, as described above.

The heating of the opposed front and rear panels can be performed in a chamber (e.g. furnace for heating, or furnace for sealing and exhausting). It is preferable to heat the opposed front and rear panels in the furnace while supplying the cleaning gas, in which case the cleaning gas supply is commenced at a normal temperature. There is no restriction on the heating temperature as long as the denatured layer component (e.g. impurities such as CO₃²⁻ or OH⁻ that have been contained in the protective layer) can be released from the protective layer. The heating temperature may be in the range of from about 350 to 450° C. for example, only in view of the cleaning.

The cleaning gas to be supplied or blown is preferably a dry gas, and particularly preferably a gas that is inactive with respect to the protective layer. As an inert gas, for example, a nitrogen gas may be used. A noble gas such as helium, argon, neon or xenon may also be used. It is particularly desired to use an oxygen-free gas as the cleaning gas since it effectively prevents the residual organic component inside the panels from being burned, which leads to a prevention of a carbonation of the protective layer. It is also preferred that the cleaning gas to be supplied includes very little moisture. For example, it is preferred that the water content of the cleaning gas to be supplied is 1 ppm or less. As used herein, “water content of the cleaning gas (ppm)” means the proportion of water or water vapor in the total volume of the gas (standard condition of 1 atmosphere at 0° C.) in terms of part per million, and represents a value measured by a conventional dew point meter. Since the nitrogen gas is expensive, the use of dry air makes the PDP production more cost effective. While the optimum flow rate of the cleaning gas depends on the panel size, number and size of the gas supply openings, thickness of the glass frit sealing member and size of surface irregularity of the glass frit sealing member and the other factors, it is roughly in the range of from 1 SLM to 100 SLM (SLM is a unit for expressing a volume (L) of the supplied gas per one minute in the standard condition). The insufficient flow rate of the cleaning gas may allow the outside air to intrude or an insufficient cleaning of the protective layer to occur, whereas the excessive flow rate of the cleaning gas may be disadvantageous in terms of not only cost but also the possible deformation of the front and rear panels.

Although the top of the annular glass frit sealing member is in contact with the substrate, the top of the annular glass frit sealing member is not exactly flat and has surface irregularities measuring several tens to hundred micrometers. For example, there are small gaps between the top of the annular glass frit sealing member formed on the rear panel and the surface of the front panel due to the interface irregularities. Accordingly, the cleaning gas supplied into the “space formed between the front and rear panels” via the gas supply opening can eventually be discharged through the gap (see, for example, “region M” shown in FIG. 4) between the annular glass frit sealing member and the substrate.

According to the method of the present invention, the heating treatment is performed together with the supply of the cleaning gas, the front and rear panels are sealed with each other while cleaning the protective layer. More specifically, the front panel and the rear panel are bonded together at their peripheries in an airtight state by heating and melting the annular glass frit sealing member while introducing the cleaning gas into the space formed between the opposed front and rear panels. There is no restriction on the heating temperature for the sealing treatment as long as the melting of the annular glass frit sealing member is achieved. Such heating temperature may be a “sealing temperature” that is the same as those used in the conventional PDP production, for example in the range of from 400 to 500° C. (the phrase “sealing temperature” refers to a temperature at which the front panel and the rear panel are sealed together airtight by a sealing member (i.e. glass frit material)). Detailed description will be given with this regard. The supply of the cleaning gas is commenced at a normal temperature. The opposed front panel and the rear panel are heated in a furnace during the supply of the cleaning gas. When the temperature exceeds the softening point of the glass frit, the annular glass frit sealing member then softens and fills the gap formed between the sealing member and the front panel. Namely, the surface irregularity existing on top of the annular glass frit sealing member gradually disappear by the soften and filled glass frit. The opposed front and rear panels are held in a temperature range (e.g. temperature range of about 10 to 70° C. higher than the melting point of the glass frit) in which the annular glass frit member is completely melted for several minutes to ten several minutes, followed by a cooling treatment thereof to harden the glass frit and thereby sealing the front panel and the rear panel with each other.

Typically, according to the method of the present invention, the cleaning gas is supplied into the space between the front and rear panels until the point in time when a softening point of the annular glass frit sealing member is reached. The phrase “softening point” used in this specification and claims refers to a temperature at which the glass frit of the annular glass frit sealing member softens. For example, the softening point may be a temperature ranging from about 380 to 480° C. (for example, about 430° C.). According to the method of the present invention, the supply of the cleaning gas is stopped after the front and rear panels have been sealed with each other. Thereby, an increase in an internal pressure of the panels is prevented, and thereby preventing the deformation of the front panel and the rear panel. More specifically, if the supply of the cleaning gas is continued even after the front and rear panels have been sealed, the cleaning gas, which has been introduced into the space between the opposed front and rear panels, cannot escape from the inner space of the panels to the outside, and thus the volume of the cleaning gas is accumulated inside the panels and the internal pressure inside the panels increases, resulting in the deformation of the panels. In this regard, according to the present invention, the supply of the cleaning gas is stopped after the front and rear panels have been sealed with each other, and thereby the undesirable deformation of the panels is avoided.

After the sealing of the front and rear panels, the space between the front and rear panels is evacuated by exhausting the internal gas thereof while keeping the panels at a temperature being somewhat lower than the sealing temperature (i.e., temperature at which a solidification of the glass frit is maintained, and such temperature is lower than the melting point of the glass frit for example by about 10 to 50° C.).

After the completion of the evacuation, the internal space of the front and rear panels is filled with the discharge gas (the pressure of the filled gas may be in the range of from about 30 Torr to 300 Torr). The discharge gas to be filled may be a mixture gas of Xe and Ne. Alternatively, the space may also be filled with Xe only, or a mixture gas of He and Xe. The exhaustion and filling of the gas may be performed via the gas supply opening (i.e. through hole that has been used for the supply of the cleaning gas). That is, the space may be evacuated and subsequently filled with the discharge gas via the gas supply opening (i.e. through hole) that has been used for the introduction of the cleaning gas through a valve switching operation. The filling of the discharge gas means the supply of the discharge gas into the discharge space, which leads to a completion of the PDP.

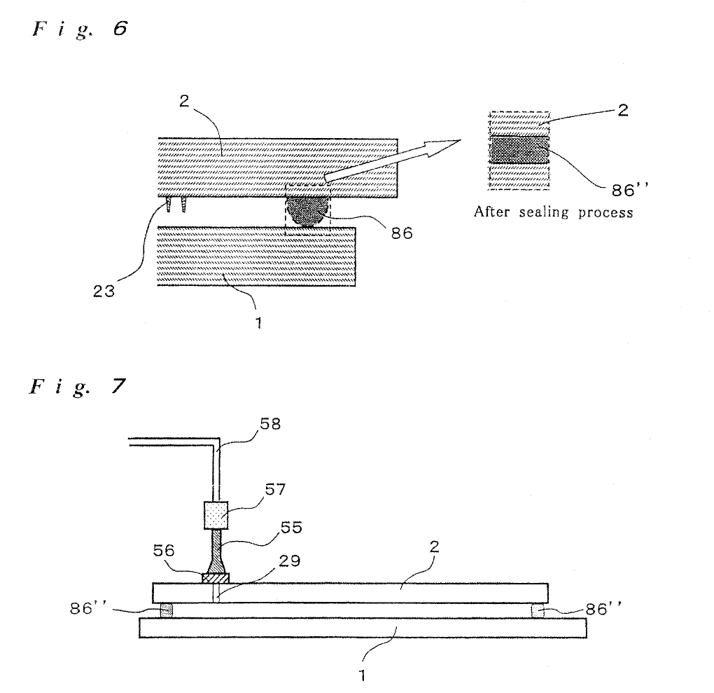

In FIG. 7, the through hole (29) provided in the rear panel (2) is illustrated. The “through hole” may have any shape, form and size as long as it enables to exhaust the internal gas of the opposed front and rear panels and to supply the discharge gas (for example, in the case of a circular through hole, the diameter thereof is in the range of from about 1 to 20 mm). The “through hole (29)” and parts associated with the through hole will be described in detail. As shown in FIG. 7, the tip tube (55) is provided above the through hole (29) via a frit ring (56). The tip tube (55) is connected, at the end thereof, with a chuck head (57) that constitutes an end of the pipe (58). The chuck head (57) has a water-cooled pipe and a sealing mechanism (not shown) so as to maintain the system airtight even when the chip tube (55) and the pipe (58) are heated up to the sealing temperature. The gas supply apparatus and the exhaust apparatus (not shown) are connected to the pipe (58). As a result, via the through hole, the gas can be purged or exhausted from the space between the opposed front and rear panels and also the discharge gas can be supplied to the space. The frit ring (56) is an annular solid part composed of a solidified glass frit material. Therefore, when the temperature of the furnace is raised up to the melting temperature of the glass frit material and then fallen, the frit ring (56) is allowed to be melted and then solidified, which leads to an achievement of the bonding between the rear panel (2) and the chip tube (55).

### (Protective Layer Formed According to the Present Invention)

The component of the protective layer, which can be one of features of the present invention, will be described in detail below. The protective layer (16) is preferably composed of a base film (16a) and aggregated particles (16b′), as shown in FIG. 3(b). The base film is formed on the dielectric layer (15). The aggregated particles (16b′), which consist of a plurality of crystal particles (16b) of magnesium oxide (MgO), is disposed on the base film (16a). As for the base film (16a), it is preferably made of at least one metal oxide selected from among magnesium oxide (MgO), calcium oxide (CaO), strontium oxide (SrO) and barium oxide (BaO). More specifically, according to the present invention, the base film (16a) of the protective layer (16) is preferably made of a metal oxide consisting of at least two oxides selected from among magnesium oxide (MgO), calcium oxide (CaO), strontium oxide (SrO) and barium oxide (BaO).

The base film (16a) may be formed by a thin film process using pellets of a oxide selected from among magnesium oxide (MgO), calcium oxide (CaO), strontium oxide (SrO) and barium oxide (BaO), or pellets prepared by mixing these oxides. As the thin film process, a known process such as an electron beam vapor deposition process, a sputtering process or an ion plating process may be used. The upper limit of pressure that can be practically used is about 1 Pa for the sputtering process, and about 0.2 Pa for the electron beam vapor deposition process (that is an example of vapor deposition processes). With regard to the atmosphere for the forming of the base film (16a), it is preferable to carry out the thin film process in a closed condition being isolated from the outside, in order to prevent the contact with the moisture and the adsorption of the impurities. By controlling the atmosphere in which the base film is formed, the base film (16a) made of the metal oxide with a desired electron releasing characteristic is obtained.

The aggregated particles (16b′), which are composed of the crystal particles (16b) made of magnesium oxide (MgO) on the base film (16a), will be described below. The crystal particles (16b) can be produced by a gas phase synthesis process or a precursor calcining process. In the gas phase synthesis process, magnesium with purity of 99.9% or higher is heated in an inert gas atmosphere, and then a small amount of oxygen is introduced into the atmosphere. As a result, the magnesium is directly oxidized to form the crystal particles (16b) of magnesium oxide (MgO).

In the precursor calcining process, a precursor of magnesium oxide (MgO) is uniformly heated at a temperature as high as about 700° C. or higher, and is then gradually cooled down to produce the crystal particles (16b) of magnesium oxide (MgO). The precursor may be one or more kinds of compound selected from among magnesium alkoxide (Mg(OR)₂), magnesium acetylacetone (Mg(acac)₂), magnesium hydroxide (Mg(OH)₂), magnesium carbonate (MgCO₂), magnesium chloride (MgCl₂), magnesium sulfate (MgSO₄), magnesium nitrate (Mg(NO₃)₂) and magnesium oxalate (MgC₂ O₄). Some of these compounds may be in the form of hydrate, and in this regard such hydrate can be used in the present invention. The above compound is prepared so as to produce magnesium oxide (MgO) with purity of 99.95% or higher and preferably 99.98% or higher after being calcined. In case the compound contains alkaline metal or elements such as B, Si, Fe or Al as impurities with a concentration thereof higher than a certain level, an undesired fusing of particles or sintering may occur during the heat treatment, and thereby inhibiting a production of crystal particles of magnesium oxide (MgO) with high crystallinity. For this reason, it is necessary to take measures such as removing impurity elements from the precursor.

The crystal particles (16b) of magnesium oxide (MgO) produced by any one of the processed described above are dispersed into a solvent, and the resulting dispersion liquid is spread over the surface of the base film (16a) by spraying process, screen printing process, slit coating process, electrostatic application process or the like. Thereafter the solvent of the dispersion liquid is removed by drying process, followed by a calcining process. As a result, the crystal particles (16b) of magnesium oxide (MgO) are fixed or secured on the surface of the base film (16a).

The process of distributing and fixing the crystal particles (16b) of magnesium oxide (MgO) onto the surface of the base film (16a) is preferably performed at a low temperature of about 400° C. or lower, in order to suppress a reaction of the base film (16a) with impurities.

Furthermore, the protective layer, which may characterize the present invention, will be described in detail. According to the method of the present invention, the protective layer of the front panel is formed from a metal oxide consisting of at least two oxides selected from among magnesium oxide, calcium oxide, strontium oxide and barium oxide, the metal oxide having a peak diffraction angle between the minimum diffraction angle and the maximum diffraction angle which are selected among the diffraction angles given by respective ones of the oxides with respect to a specific orientation plane in X-ray diffraction analysis. In this regard, it is preferable to form the base film (16a) of the protective layer from such metal oxide. In other words, the base film (16a) of the protective layer is formed from a metal oxide consisting of at least two oxides selected from among magnesium oxide (MgO), calcium oxide (CaO), strontium oxide (SrO) and barium oxide (BaO), the metal oxide having a peak diffraction angle between the minimum diffraction angle and the maximum diffraction angle which are selected among the diffraction angles given by respective ones of the oxides constituting the above metal oxide of the base film (16a)) with respect to a specific orientation plane in X-ray diffraction analysis.

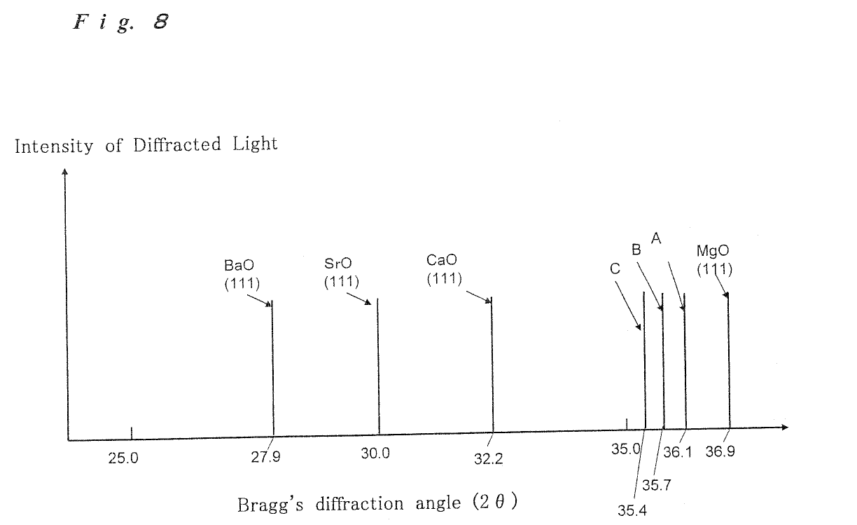

FIG. 8 is a diagram showing the result of X-ray diffraction analysis on the base film (16a) constituting the protective layer (16) of the PDP according to the embodiment of the present invention. FIG. 8 also shows the results of X-ray diffraction analysis conducted separately on magnesium oxide (MgO), calcium oxide (CaO), strontium oxide (SrO) and barium oxide (BaO).

In FIG. 8, Bragg's diffraction angle (2θ) is plotted along the horizontal axis and X-ray diffraction intensity is plotted along the vertical axis. The diffraction angle is shown by the unit of degrees, with 360 degrees meaning one full turn. The diffraction intensity is shown with arbitrary unit. In the diagram, a crystal orientation plane, which corresponds to specific orientation planes, is indicated in parentheses. As shown in FIG. 8, it can be seen that, with respect to the crystal orientation (111), calcium oxide (CaO) has a diffraction angle of 32.2 degrees, magnesium oxide (MgO) has a diffraction angle of 36.9 degrees, strontium oxide (SrO) has a diffraction angle of 30.0 degrees and barium oxide (BaO) has a diffraction angle of 27.9 degrees as a peak diffraction angle.

FIG. 8 also shows the result of X-ray diffraction analysis in a case of the base film (16a) made of a metal oxide consisting of the two oxides selected from magnesium oxide (MgO), calcium oxide (CaO), strontium oxide (SrO) and barium oxide (BaO). In FIG. 8, the result of X-ray diffraction analysis of the base film (16a) formed from magnesium oxide (MgO) and calcium oxide (CaO) is shown as “A”, the result of X-ray diffraction analysis of the base film (16a) formed from magnesium oxide (MgO) and strontium oxide (SrO) is shown as “B”, and result of X-ray diffraction analysis of the base film (16a) formed from magnesium oxide (MgO) and barium oxide (BaO) is shown as “C”.

As is apparent from the result of X-ray diffraction analysis shown in FIG. 8, the point A represents a peak at diffraction angle of 36.1 degrees between the diffraction angle of 36.9 degrees of magnesium oxide (MgO) that is the maximum diffraction angle among the individual oxides and the diffraction angle of 32.2 degrees of calcium oxide (CaO) that is the minimum diffraction angle among the individual oxides with respect to the crystal orientation plane (111) that is the specific orientation plane. Similarly, the point B and point C represent peaks at diffraction angles of 35.7 degrees and 35.4 degrees, respectively, between the maximum diffraction angle and the minimum diffraction angle among the individual oxides with respect to the crystal orientation plane (111).

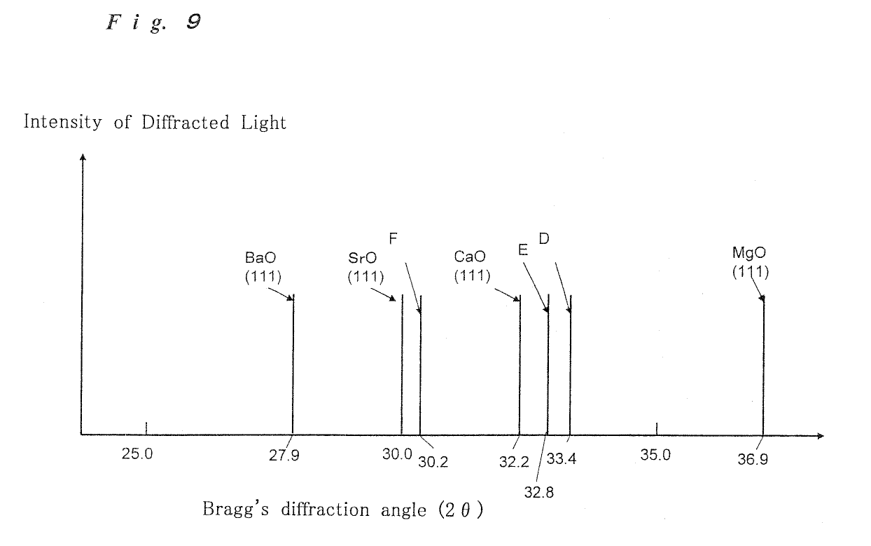

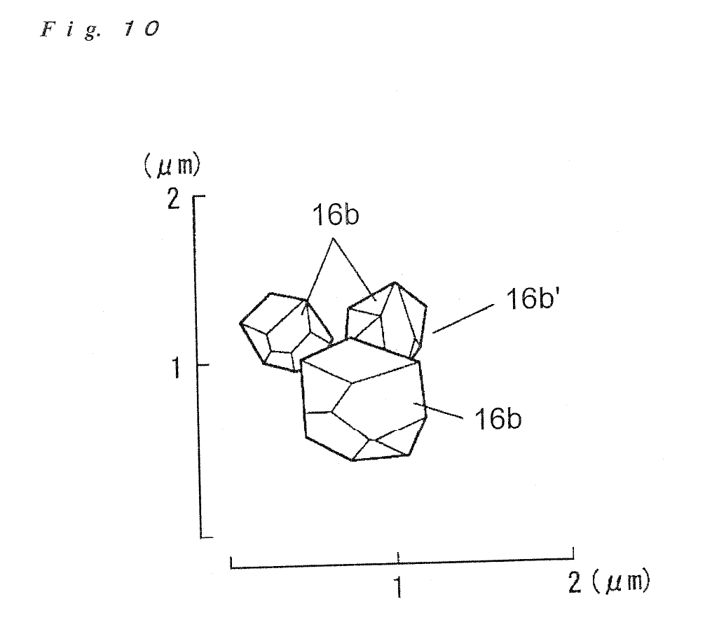

Similarly to FIG. 8, FIG. 9 shows the results of X-ray diffraction analysis in a case of the base film (16a) made of a metal oxide consisting of the three or more oxides selected from magnesium oxide (MgO), calcium oxide (CaO), strontium oxide (SrO) and barium oxide (BaO). In FIG. 9, the result of X-ray diffraction analysis of the base film (16a) formed from magnesium oxide (MgO), calcium oxide (CaO) and strontium oxide (SrO) is shown as “D”, the result of X-ray diffraction analysis of the base film (16a) formed from magnesium oxide (MgO), calcium oxide (CaO) and barium oxide (BaO) is shown as “E”, and the result of X-ray diffraction analysis of the base film (16a) formed from calcium oxide (CaO), strontium oxide (SrO) and barium oxide (BaO) is shown as “F”.

As is apparent from the results of X-ray diffraction analysis shown, point D represents a peak at a diffraction angle of 33.4 degrees between the diffraction angle of 36.9 degrees of magnesium oxide (MgO) that is the maximum diffraction angle among the individual oxides and the diffraction angle of 30.0 degrees of strontium oxide (SrO) that is the minimum diffraction angle with respect to the crystal orientation plane (111) that is the specific orientation plane. Similarly, point E and point F represent peaks at diffraction angles of 32.8 degrees and 30.2 degrees, respectively, between the maximum diffraction angle and the minimum diffraction angle among the individual oxides with respect to the crystal orientation plane (111).

As can be seen from above, the base film (16a) of the PDP protective layer of the present invention, regardless of whether it is formed from a metal oxide consisting of two or three individual oxides, has a peak diffraction angle between the minimum diffraction angle and the maximum diffraction angle which are selected among the diffraction angles given by respective ones of the metal oxides constituting the above metal oxide of the base film (16a) in a specific orientation plane in X-ray diffraction analysis.

While the crystal orientation plane (111) has been dealt with as the specific orientation plane in the above description, peak position of the metal oxide is similar to those described above also in a case where another crystal orientation plane is dealt with.

Calcium oxide (CaO), strontium oxide (SrO) and barium oxide (BaO) have depths with respect to the vacuum level in a shallow region compared to that of magnesium oxide (MgO). As a result, when electrons existing in the energy levels of calcium oxide (CaO), strontium oxide (SrO) and barium oxide (BaO) undergo transition to the base level of xenon (Xe) ion, it is expected that the number of electrons released by the Auger effect becomes larger than that of a case of transition from the energy level of magnesium oxide (MgO).

A metal oxide having the feature shown in FIG. 8 and FIG. 9 with regard to the result of X-ray diffraction analysis has energy level between those of the individual oxides that constitute them. As a result, the energy level of the base film (16a) also lies between those of the individual oxides, and is sufficient for the other electrons to acquire the energy enough to exceed the vacuum level and be released by the Auger effect.

Thus, the base film (16a) provides better secondary electron emission characteristic compared to the case of individual magnesium oxide (MgO), so that electric discharge sustaining voltage can be decreased. This means that the discharge voltage can be decreased and the PDP operating at a low voltage with high brightness can be realized when the partial pressure of xenon (Xe) used as the discharge gas is increased for increasing the brightness.

The electric discharge sustaining voltage of the PDP obtained with the method of the present invention when the constitution of the base film (16a) is altered will be described below. A sample A (the base film is formed from magnesium oxide and calcium oxide as the metal oxide), a sample B (the base film is formed from magnesium oxide and strontium oxide as the metal oxide), a sample C (the base film is formed from magnesium oxide and barium oxide as the metal oxide), a sample D (the base film is formed from magnesium oxide, calcium oxide and strontium oxide as the metal oxide) and a sample E (the base film is formed from magnesium oxide, calcium oxide and barium oxide as the metal oxide) were prepared as the sample of the present invention. A comparative example was prepared by forming the base film from magnesium oxide.

The electric discharge sustaining voltage measured on samples A to E was 90 for the sample A, 87 for the sample B, 85 for the sample C, 81 for the sample D and 82 for the sample E, relative to the value of the comparative example that was assumed to be 100.

Increasing the partial pressure of xenon (Xe) as the discharge gas from 10% to 15% causes brightness to increase by about 30%, while causing the electric discharge sustaining voltage to increase by about 10% in the comparative example where the base film (16a) is formed from magnesium oxide (MgO) only. In the PDP obtained with the method of the present invention, in contrast, the electric discharge sustaining voltage can be decreased by about 10% to 20% in any of the sample A, sample B, sample C, sample D and sample E, compared to the comparative example, thus making it possible to keep the electric discharge starting voltage within the range of normal operation thereby to realize the PDP that is capable of achieving high brightness while operating at a low voltage.

Calcium oxide (CaO), strontium oxide (SrO) and barium oxide (BaO) have high reactivity individually and are apt to react with impurities leading to a decrease in the electron releasing performance, although use of these metal oxides lowers the reactivity and forms such crystal structure that is less prone to the inclusion of impurities and oxygen defects. That is, use of calcium oxide (CaO), strontium oxide (SrO) and barium oxide (BaO) in the form of metal oxide suppresses electrons from being released excessively during the operation of the PDP, so as to obtain reasonable effect of electron releasing characteristic in addition to the double effects of low voltage operation and secondary electron emission performance. The electric charge retaining performance is advantageous for ensuring reliable writing discharge by retaining wall electrons that have been accumulated during the initialization period and preventing writing failure from occurring during the writing period.

The aggregated particles (16b′) composed of a plurality of crystal particles (16b) of magnesium oxide (MgO) deposited on the base film (16a) will be described in detail below. The aggregated particles (16b′) of magnesium oxide (MgO) have proved to have the effect of suppressing the delay in discharge during writing discharge and the effect of improving the temperature dependency of the delay in electric discharge, in experiments conducted by the inventors of the present invention. Accordingly, in the present invention, the aggregated particles (16b′) are disposed as the source of primary electrons that is required during the rise of the discharge pulse, by taking advantage of better primary electron releasing characteristic of the aggregated particles (16b′) than that of the base film (16a).

“Delay in electric discharge” is considered to be caused mainly by the shortage in the number of primary electrons, which serve as the trigger at the start of electric discharge, released from the surface of the base film (16a) into the discharge space. Therefore, in order to stabilize the supply of primary electrons into the discharge space, the aggregated particles (16b′) of magnesium oxide (MgO) are disposed in a dispersed manner over the surface of the base film (16a). This leads to the elimination of the delay in electric discharge, with abundant of electrons supplied in the discharge space during the rise of the discharge pulse. As a result, such a primary electron releasing characteristic enables it to operate the PDP at a high speed with Good electric discharge response characteristic even during high definition display operation. The constitution wherein the aggregated particles (16b′) of metal oxide are disposed on the surface of the base film (16a) achieves the effect of suppressing the “delay in electric discharge” during writing discharge and the effect of improving the temperature dependency of the “delay in electric discharge”.

Thus the PDP obtained with the method of the present invention is capable of operating at a high speed at a low voltage even during high definition display operation and achieving high quality picture display while suppressing lighting failure, by the protective layer composed of the base film (16a) that has the double effects of low voltage operation and electric charge retaining, and the aggregated particles (16b′) of magnesium oxide (MgO) that have the effect of preventing the delay in electric discharge.

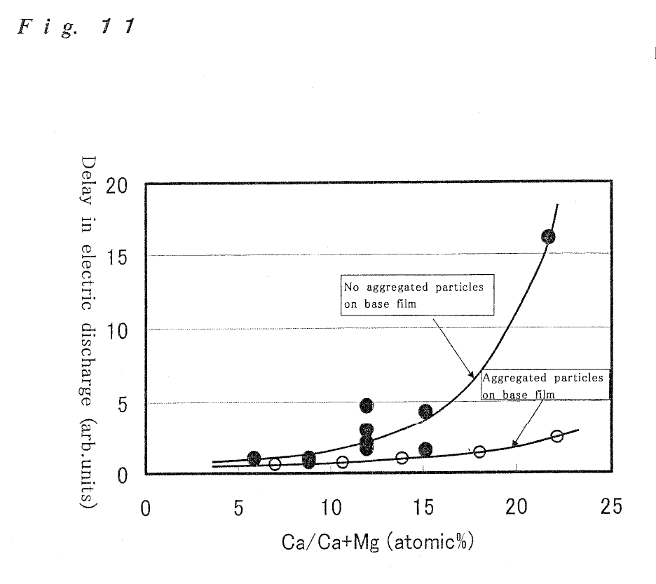

In a preferred embodiment of the present invention, the aggregated particles (16b′) composed of several crystal particles (16b) are dispersed on the base film (16a), so that a plurality of the aggregated particles are distributed so as to deposit substantially uniformly over the entire surface of the base film. FIG. 10 is an enlarged diagram showing the aggregated particles (16W). As shown in FIG. 10, the aggregated particles (16b′) are clusters of crystal particles (16b) with predetermined primary size that have been aggregated together. Thus the aggregated particles (16b′) take the form of clusters of the primary particles aggregated by the electrostatic attraction or van der Waals forces, not by a strong bonding force as in a solid. In other words, the aggregated particles (16b′) are bonded together such that a part or whole of them are allowed to dissociate to turn a form of the primary particles by an extraneous influence such as ultraviolet excitation. The size of the aggregated particles is preferably about 1 μm. And also the crystal particles preferably have polyhedral shape that has seven or more faces such as dodecahedron or quadridecahedron.

The particle size of the primary particles regarding the crystal particles (16b) can be controlled by the conditions of forming the crystal particles (16b). For example in a case where the crystal particles (16b) are formed by calcining an MgO precursor such as magnesium carbonate or magnesium hydroxide, the particle size can be controlled by adjusting the calcining temperature and calcining atmosphere. While the calcining temperature may be set within a range of from 700 to 1500° C., the setting the calcining temperature at a relatively high level of about 1000° C. or higher makes it possible to control the particle size to about 0.3 to 2 μm. Moreover, when the crystal particles (16b) are formed by heating an MgO precursor, the aggregated particles (16b′) can be obtained as a plurality of the primary particles are aggregated together in the formation process.

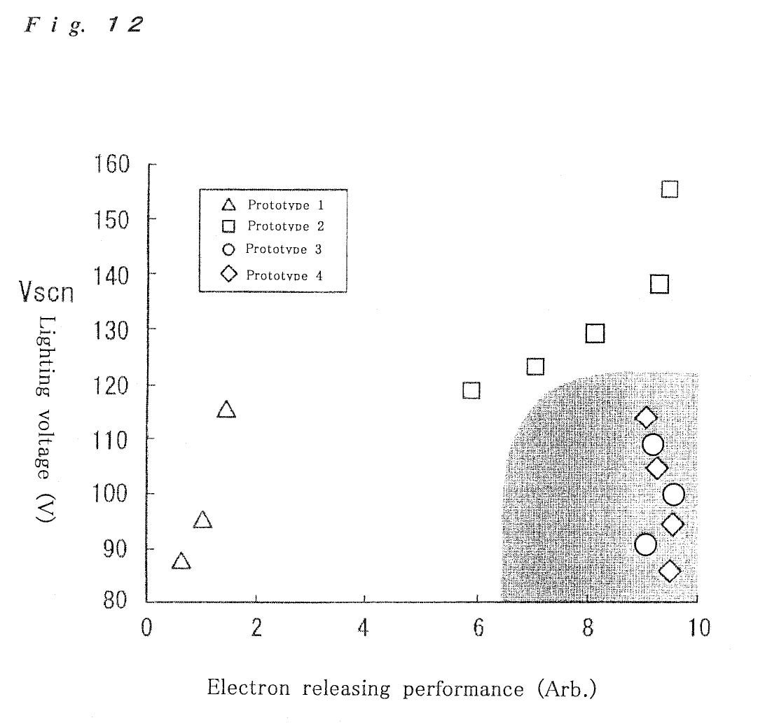

FIG. 11 shows the relationship between the delay in electric discharge and the calcium (Ca) concentration in the protective layer, in a case where the base film (16a) is formed from metal oxides of magnesium oxide (MgO) and calcium oxide (CaO) according to the embodiment of the present invention. The base film (16a) is formed from metal oxides of magnesium oxide (MgO) and calcium oxide (CaO), and the metal oxide is conditioned so that X-ray diffraction analysis on the surface of the base film (16a) shows a peak diffraction angle between the diffraction angle at which the peak of magnesium oxide (MgO) appears and the diffraction angle at which the peak of calcium oxide (CaO) appears. FIG. 11 shows a case where only the base film (16a) is provided as the protective layer, and a case a where the aggregated particles (16b′) are disposed on the base film (16a), and the delay in discharge is shown with reference to a case where the base film (16a) does not contains the calcium oxide (Ca).

The electron releasing performance is an indicator of which value being higher indicates a larger number of released electrons, and is represented by the number of primary electrons released, which is determined by the surface condition and the type of gas. The number of primary electrons released can be determined by measuring the current of electrons released from the surface when the surface is irradiated with ion beam or electron beam, although it is difficult to evaluate the front panel surface of the PDP in non-destructive manner. Therefore, the method described in Japanese Patent Kokai Publication No. 2007-48733 was employed. Specifically, as the delay electric in charge, a value called the statistic delay period that indicates the aptness to electric discharge was measured, and the inverse of the value is integrated to give a value that corresponds to the number of primary electrons released and the line shape. This value is used in the evaluation. The delay in electric discharge refers to the time elapsed after the rising of the pulse till the electric discharge occurs. The delay in electric discharge is considered to be caused mainly by the difficulty of the primary electrons, which serve as the trigger at the start of discharge, to be released from the surface of the protective layer into the discharge space.

As is apparent from FIG. 11, the delay in electric discharge increases as the concentration of calcium (Ca) increases in the case where only the base film (16a) is provided. While on the other hand, the delay in electric discharge can be greatly decreased by disposing the aggregated particles (16b′) on the base film (16a), so that the delay in electric discharge hardly increases even when the concentration of calcium (Ca) increases.

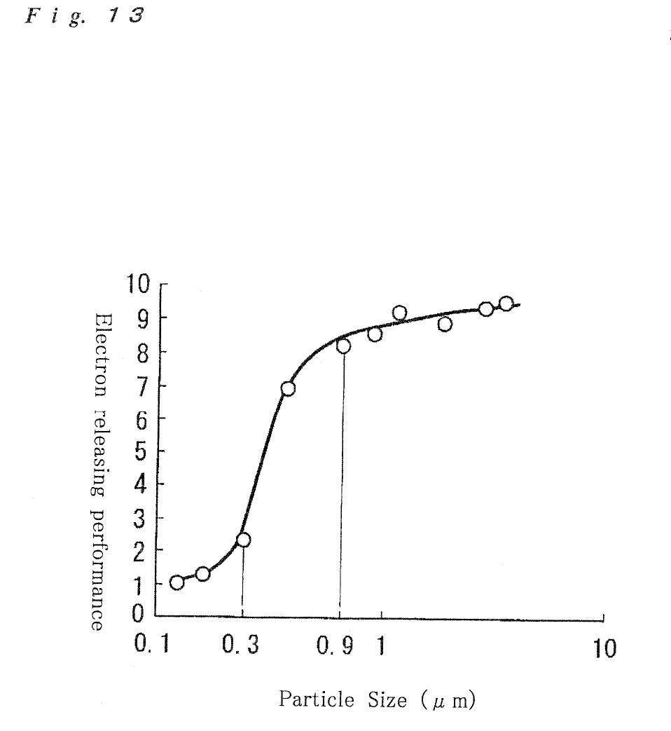

The results of experiment conducted to investigate the effects of the protective layer that has the aggregated particles (16b′) according to the embodiment of the present invention will be described below. First, PDPs having the base film (16a) of different constitutions and the aggregated particles (16b′) provided on the base film (16a) were fabricated as prototypes. Prototype 1 is a PDP having the protective layer (16) that consists of only the base film (16a) of magnesium oxide (MgO), prototype 2 is a PDP having the protective layer that consists of only the base film (16a) of magnesium oxide (MgO) doped with impurity such as Al, Si or the like, and prototype 3 is a PDP having the protective layer whereon primary particles of crystal particles (16b) of magnesium oxide (MgO) spread and deposited on the base film (16a) of magnesium oxide (MgO). Prototype 4 includes a protective layer made of sample A described previously. That is, the protective layer comprises the base film (16a) formed from metal oxides of magnesium oxide (MgO) and calcium oxide (CaO), and aggregated particles (16b′) composed of aggregated crystal particles (16b) deposited on the base film (16a) so as to be distributed substantially uniformly over the entire surface thereof. The base film (16a) is conditioned so as to show a peak diffraction angle between the minimum diffraction angle and the maximum diffraction angle of the peak observed in X-ray diffraction analysis of the oxide that constitutes the base film (16a). The minimum diffraction angle in this case is 32.2 degrees of calcium oxide (CaO) and maximum diffraction angle is 36.9 degrees of magnesium oxide (MgO), while the base film 91 shows a peak of diffraction at diffraction angle of 36.1 degrees. These PDPs were evaluated for the electron releasing performance and the electric charge retaining performance. The results are shown in FIG. 12. The electron releasing performance was evaluated by the method described previously, and the electric charge retaining performance was evaluated in terms of the voltage applied to the scan electrode (hereinafter referred to a Vscn lighting voltage) that is required for suppressing the release of electric charges when produced as the PDP. A lower Vscn lighting voltage means higher charge retaining capability. This means that components having lower withstanding voltage and/or lower capacity can be used for the power supply and electric components when designing the PDP. Currently commercialized products use semiconductor elements such as MOSFET that have withstanding voltage of about 150 V for applying the scan voltage to the panel, while it is desired to suppress the Vscn lighting voltage to about 120 V or lower in consideration of variation attributed to the temperature.

As can be seen from FIG. 12, in the case of prototype 4 that was made by spreading the aggregated particles (16b′) formed from aggregated single crystal particles (16b) of magnesium oxide (MgO) deposited on the base film (16a) so as to distribute the aggregated particles (16b′) substantially uniformly over the entire surface of the base film (16a), the Vscn lighting voltage can be controlled to 120 V or lower in the evaluation of the electric charge retaining performance and, in addition, far higher electron releasing characteristic can be achieved than that of prototype 1 of which protective layer was formed from magnesium oxide (MgO) only.

Electron releasing capability and charge retaining capability of the protective layer of the PDP are generally incompatible with each other. For example, electron releasing performance may be improved by changing the film forming conditions for the protective layer or doping the protective layer with impurity such as Al, Si or Ba, although it results in an increase in the Vscn lighting voltage as the side effect.

The PDP of prototype 4 shows the electron releasing performance 8 times higher than that of prototype 1 of which protective layer was formed from magnesium oxide (MgO) only, and achieves the charge retaining capability with Vscn lighting voltage of 120 V or lower. This is advantageous for the PDP that is designed with an increasing number of scan lines for higher definition display and smaller cell size, thus making it possible to meet the requirements of the electron releasing capability and the charge retaining capability at the same time and decrease the delay in electric discharge, thereby achieving higher quality pictures.

The particle size of the crystal particles (16b) will be described in detail below. In the description that follows, “particle size” means a mean particle size and the mean particle size means an accumulated volume mean particle size (D50).

FIG. 13 shows the results of experiment conducted to investigate the electron releasing performance of prototype 4 of the present invention shown in FIG. 12 by changing the particle size of the crystal particles (16b). The particle size of the crystal particles (16b) shown in FIG. 13 was measured by observing the crystal particles under SEM. As shown in FIG. 13, the small particle size of about 0.3 μm leads to the low electron releasing performance, while the particle size of about 0.9 μm or larger leads to the high electron releasing performance.

In order to increase the number of electrons released in the discharge cell, it is desirable that there are more crystal particles (16b) per unit area of the base film. According to the experiment conducted by the inventors of the present application, however, it was found that the crystal particles placed on a portion that corresponds to the top of the barrier rib of the rear panel which makes contact with the protective layer of the front panel can damage the top of the barrier rib, resulting in the broken chips falling onto the phosphor layer and making the cell unable to normally turn on and off. Since the damage on the top of the barrier rib is unlikely to occur if there is no crystal particles (16b) on the top of the barrier rib, the probability of the barrier rib to be damaged become higher when the number of crystal particles (16b) deposited increases. In line with these considerations, the probability of the barrier rib to be damaged sharply increases when the particle size of the crystal particles increases to about 2.5 μm, and probability of the barrier rib can be kept relatively low when the particle size the of crystal particles is smaller than 2.5 μm.

As described above, it was found that the methods of the present invention can be stably achieved when the crystal particles (16b) with particle size in a range of from 0.9 μm to 2 μm are used in the protective layer. While the case of using the crystal particles (16b) of magnesium oxide (MgO) has been described above, similar effects can be achieved also by using other crystal particles of oxides of metals such as Sr, Ca, Ba and Al that have high electron releasing performance similarly to that of magnesium oxide (MgO). This means that the crystal particles are not limited to magnesium oxide (MgO).

If the above matters and findings on the protective layer of the present invention can be summed up, secondary electron releasing characteristic in the protective layer is improved in the obtained PDP. Even if a partial pressure of Xe gas in the discharge gas is increased to enhance the brightness of the PDP, it becomes possible to decrease a discharge starting voltage. As a result, the PDP obtained according to the present invention is excellent in terms of a display performance since a higher brightness and a lower voltage driving are provided even in a case of the PDP with high definition image.

### <<Characteristic Process Operation of the Production Method of the Present Invention>>

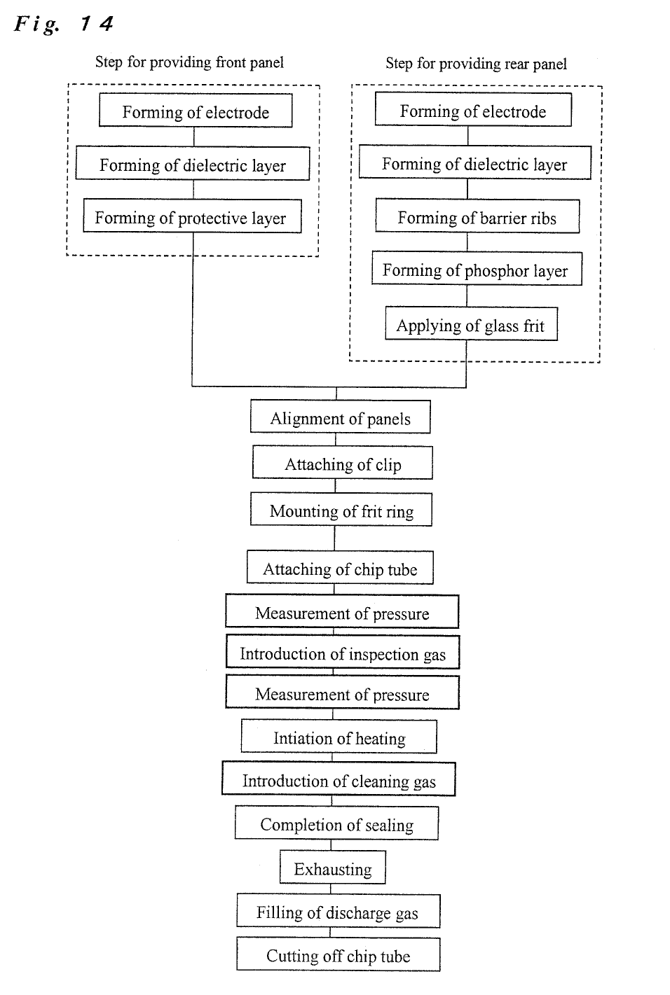

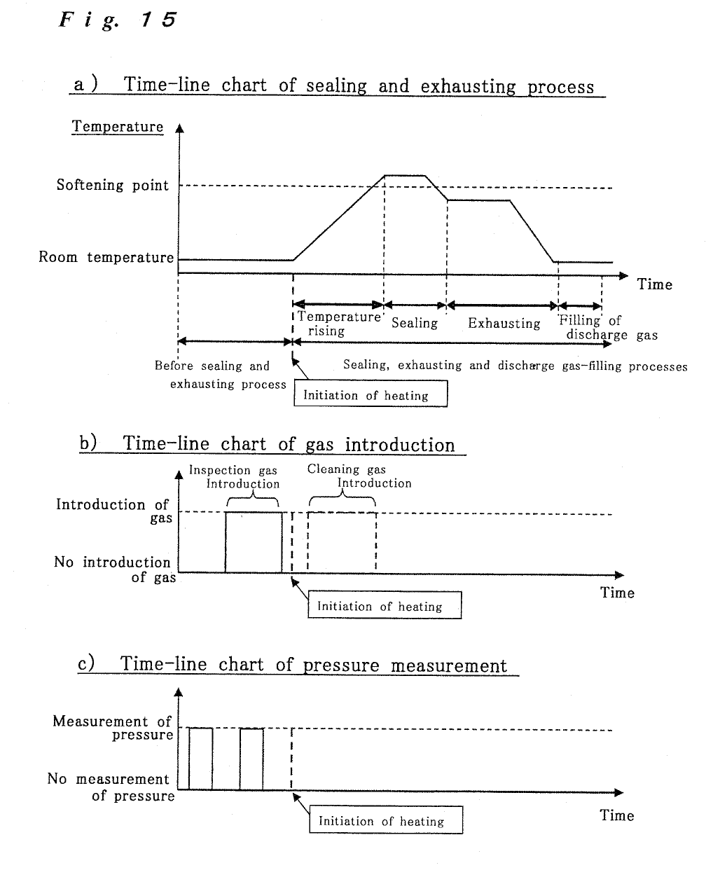

With reference to FIG. 14 to FIG. 26, a characteristic process operation of the production method of the present invention will be described below by way of example. In the present invention, the protective layer is formed from a metal oxide having the features described above. Namely the protective layer is formed of the metal oxide film comprising at least two or more oxides selected from among magnesium oxide, calcium oxide, strontium oxide and barium oxide, the metal oxide film having a peak diffraction angle between the minimum diffraction angle and the miximum diffraction angle which are selected among the diffraction angles given by respective ones of at least two oxides constituting the metal oxide with respect to the specific orientation plane of X-ray diffraction analysis of the metal oxide. Therefore, the protective layer of the PDP according to the present invention makes it possible to decrease a discharge starting voltage thereof and also decrease a delay in discharge, which leads to an achievement of the stable discharge of the PDP. In this regard, it can be said that the above metal oxides are highly reactive with water (e.g. moisture) and an impurity gas (e.g. carbon dioxide), and is likely to cause the deterioration of electric discharge characteristic as a result of the reaction therewith. In light of this, the present invention makes it possible to allow the cleaning gas to flow into the discharge space via a through hole provided in a rear panel during the sealing step, and thereby the undesirable reaction of the protective film with the impurity gas in the course of the production process of the PDP is suppressed. However, if the cleaning gas cannot be allowed to surely flow into the opposed panels, it becomes impossible to clean the protective layer. If possible, the protective layer cannot be sufficiently cleaned due to an uneven stream of the cleaning gas, and thus causing an unevenness in terms of the drive voltage and display brightness over a display surface of the panel. Therefore, as for the production method of the present invention, appropriate measures are taken in advance so as to sufficiently supply the cleaning gas into the opposed panels.

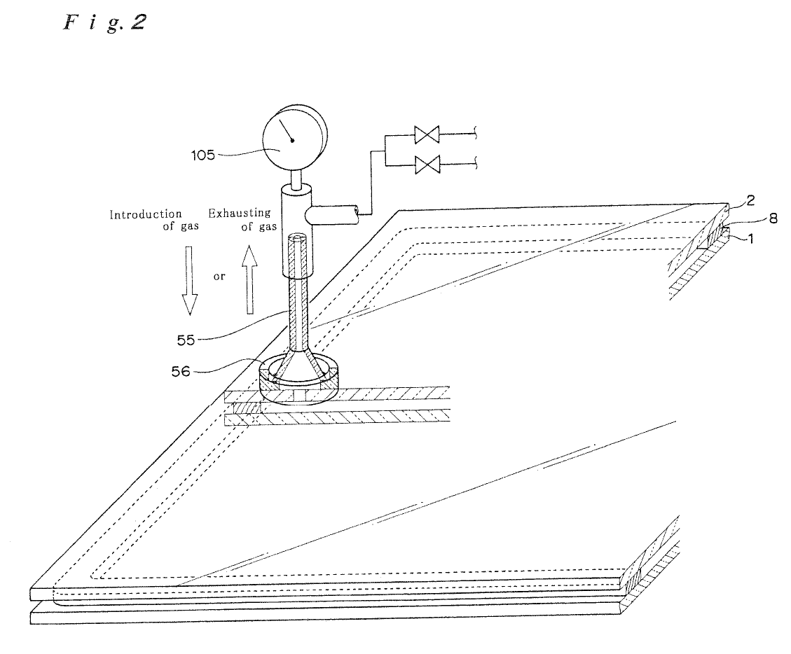

Specifically, in the production method of the present invention, “introduction of gas” or “exhausting of gas” is performed prior to the heating treatment of the step (iv), and thereby the difference in pressure between before and after the introduction or exhausting of the gas is measured (see FIG. 2). The measured pressure difference brings an understanding of an attached or connected state of the gas introduction line and/or gas exhaustion line, or an assembled state of them with the “opposed front and rear panels”. Consequently, if the attached, connected or assembled state of them is judged to be insufficient, then it is possible to reattach, reconnect or reassemble them, which leads to an achievement of a suitable cleaning of the panels. In other words, the present invention can preliminarily eliminate the insufficiently attached, connected or assembled pipeline and panels which may cause a leakage of the cleaning gas. This means that the present invention selects and uses only the pipeline and panels which contribute to an achievement of a sufficient supply of the cleaning gas in the step (iv).

### First Embodiment

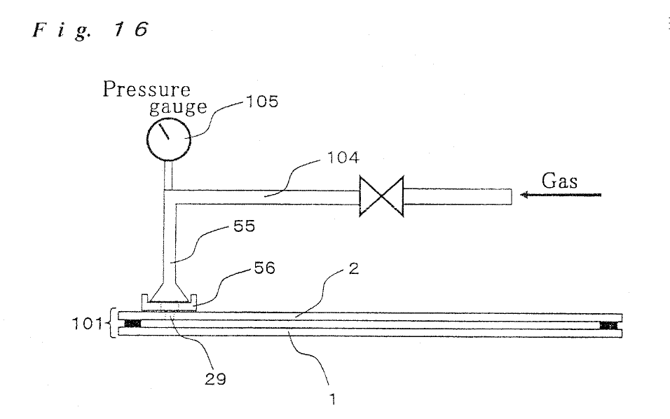

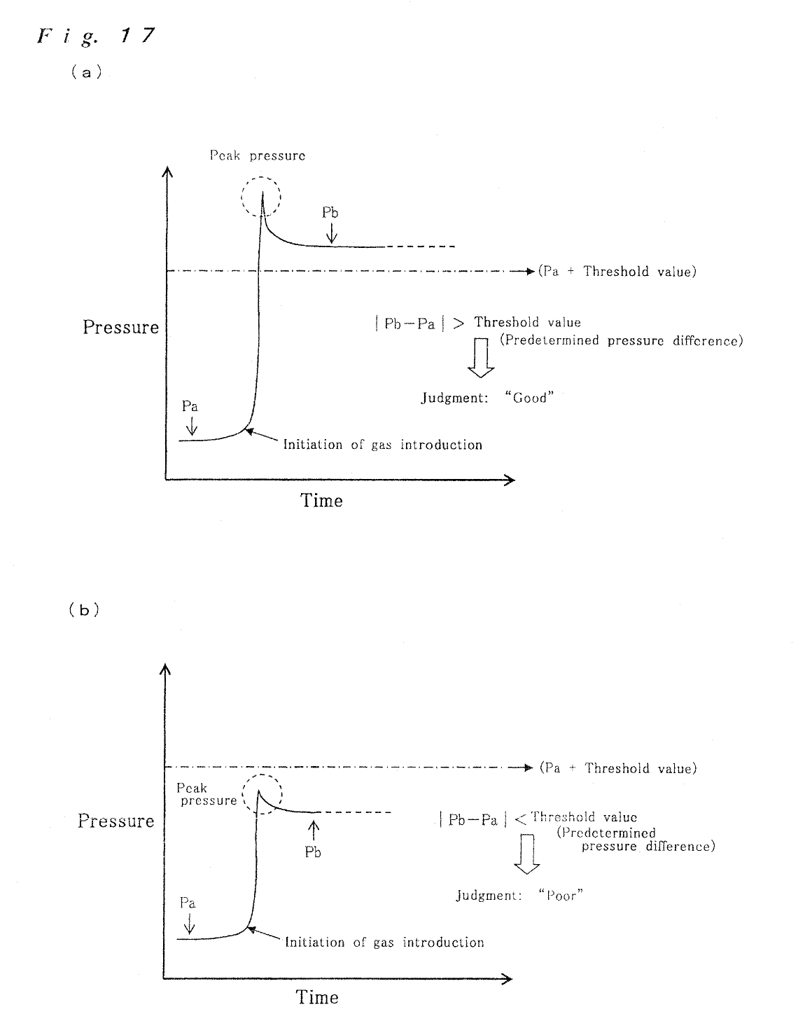

The first embodiment of the present invention will be will be described wherein an inspection gas is introduced prior to the heat treatment in the step (iv), and thereby a difference in pressure between before and after the introduction of the inspection gas is determined. A diagram for explaining about the first embodiment is shown in FIGS. 14 to 16. FIG. 14 is a flow chart showing a method for producing PDP according to the first embodiment, FIG. 15 is a process time chart thereof and FIG. 16 is a schematic view of a device for carrying out the process of the first embodiment.

In the first embodiment, the inspection gas is introduced via a chip tube (55) and a frit ring (56) which are afterward used in “vacuum exhaustion process and filling process of discharge gas to be performed after the sealing process”. Specifically, as shown in FIG. 16, the inspection gas is introduced into the panel through a chip tube or exhausting tube (55) using a line in which a pressure gauge (105) is disposed on the way to a gas piping (104) connected to an aligned panel (oppositely disposed panel) (101). In the gas introduction line, the inspection gas flows into the panels via a through hole (29) after allowing to flow through the gas piping (104), the chip tube (55) and the frit ring (56).

There is formed a generally closed space inside the aligned panels (101). Thus, if the gas introduction line is sufficiently sealed, the value of the pressure gauge (105) provided in the gas introduction line increases to some extent when the inspection gas is allowed to continuously flow. In contrast, if the gas introduction line is not sufficiently sealed, the value of the pressure gauge (105) does not remarkably increases even when the inspection gas is allowed to continuously flow.

With respect to the sealing of the gas introduction line, the chip tube (55) is pressed against the rear panel (2) via the frit ring (56) to align the tube (55) with the through hole (29). Namely, “contact surface between the chip tube (55) and the frit ring (56)” and “contact surface between the frit ring (56) and the rear panel (2)” are sealed due to a pressing force. Therefore, when foreign matters or dusts adhere to these contact surfaces, or mutual installation conditions of the chip tube (55), the frit ring (56) and the rear panel (2) (for example, “mounted state of the chip tube or the frit ring” and “positional accuracy of the chip tube and the aligned panel”) is inferior, the inspection gas is not sufficiently introduced into the panels due to leakage. In this case, the value of the pressure gauge (105) does not remarkably increase even under conditions where the inspection gas is allowed to flow. Similarly, the value of the pressure gauge (105) cannot remarkably increase when the attached state of a clip (not shown) for fixing the chip tube (55) and the frit ring (56) to the panel is inferior.

In the case where there is a leakage of gas (namely the pressure value does not greatly increase), it is impossible to sufficiently supply the cleaning gas into the panels, thus making it impossible to effectively remove impurities of the protective layer.

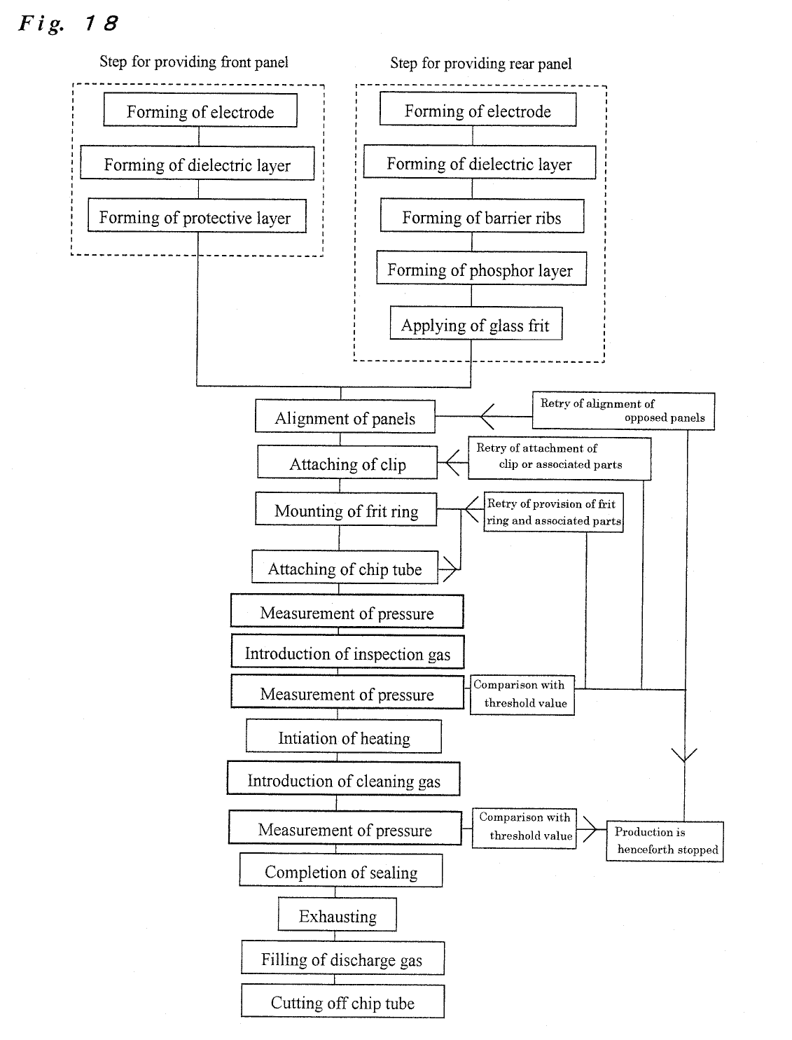

Therefore, in the present invention, a difference in pressure between before and after the introduction of an inspection gas is measured and the measured value is compared with a threshold value set in advance. When the measured pressure difference is the threshold value or more, then it is rated “Good” and a cleaning process (and sealing treatment) is initiated. On the other hand, when the difference in pressure is less than the threshold value, it is rated “Poor” and the mounting, connecting or assembling of the gas introduction line, panels and other parts associate therewith are readjusted, or the alignment of the opposed panels are readjusted (see FIG. 17). In this regard, the present invention can easily readjust them because the pressure difference is determined before the heating of the panels (see FIGS. 14 and 15). Specifically, when the pressure difference is less than threshold value, “mounted state of the chip tube and the frit ring”, “positional relationship between the chip tube and the aligned panels” and/or “attached state of the clip for fixing the chip tube and the frit ring to the panel” are readjusted, or “adhesion of foreign matters and dusts to the mounted site” are removed (see FIG. 18). A reassembling may be performed by replacement of the parts, the clip and the like, or by replacement of the front panel and the rear panel. When the pressure difference does not still reach the threshold value even after such reassembling is performed, the production process concerning the panels with a possibility of failure may be stopped. The present invention can ensure an accurate introduction of the cleaning gas into the panels after the heat treatment thereof, thus making it possible to effectively remove the impurity gas, which leads to an achievement of a stable production of the PDP with satisfactory performances.

Describing in more detail, the effects of the present invention are exerted most satisfactorily upon mass production of PDP. For example, in a case where a sealing and exhausting process and also a cleaning process are carried out in a cart-type continuous furnace which is used in mass-production factories, a plurality of panels to be treated are sequentially mounted on one cart by a robot and then the above processes are performed. Therefore, when a failures of the assembling of a chip tube, a frit ring, a clip and the like arise in some panels among a plurality of panels, the cleaning gas leakage may arise in such panels upon introducing thereof, and thereby inhibiting the cleaning gas from be introduced into the other panels, which leads to an unsatisfactory production process of the PDP. The present invention can suitably avoid such unsatisfactory production process. For example, the failures (i.e. “Poor”) can be easily detected by Sequentially mounting panels on the cart using a robot, and then measuring a difference in pressure between before and after the introduction of the inspection gas prior to the heating thereof, followed by comparing the measured value with a “threshold value” or “value of a control criterion” set in advance. Particularly according to the present invention, “Failure”/“Poor” can be detected before the initiation of heating of the sealing and exhausting process, and thus defective panels can be removed in advance. As a result, not only a capability of mass-production facilities is effectively exploited, but also a reduction in defective panels and a recycling of parts and materials are realized by converting the defective panels into the satisfactory ones through reassembling of panels or the associated parts, which leads to an achievement of a reduction in wastes.

By the way, in a conventional sealing process of the PDP, a solid frit ring is often interposed between the chip tube and the panel, followed by fixing them using a clip or the like. However, in recent years, the clip is often omitted, namely the fixation by means of the clip is often omitted in view of mass production costs and production efficiency. It can be therefore said that a process guarantee by the present invention is important.

It is preferred that the inspection gas used for determining the pressure difference is a gas of the same kind as that of the cleaning gas. In other words, the inspection gas is preferably a gas which is inactive with respect to the protective layer and is at least one kind of gas selected from the group consisting of a nitrogen gas, a noble gas and a dry air. Whereby, it is possible to understand the connected, assembled or mounted state of the gas introduction line, the alignment of the panels and the like without exerting an adverse influence on the cleaning process. The flow rate of the inspection gas is for example preferably from about 1 to 10 SLM, and more preferably from about 3 to 7 SLM although it depends on the kind and size of the gas introduction line and panels. The threshold value (pressure difference) for the judgment of “Good”/“Poor is for example preferably from about 0.5 to 10 kPa, and more preferably from about 1 to 3 kPa although it depends on the flow rate of the inspection gas, the kind and size of the gas introduction line and panels. The threshold value is not absolute and can vary depending on the ambient environment and weather conditions of the date of the production, it is preferred that a proper threshold value is adjusted based on the past findings and experiential numerical values. Immediately after the introduction of the inspection gas, the pressure may be unstable due to the quick increase of the pressure. Therefore, it is preferred to determine the pressure difference by excluding a peak pressure which may occurs immediately after the introduction of the gas. In other words, it is preferred to determine the pressure difference from “pressure Pb after the gas introduction” and “pressure Pa before the gas introduction” as shown in FIG. 17. In this case, for example, the pressure after a lapse of about 1 minute or more from the initiation of the gas introduction may be used as the “pressure Pb after the gas introduction”.

The pressure gauge used for determining the pressure difference is not particularly restricted as long as it is provided in any one point of the gas introduction line. However, in a case where the inspection gas is introduced via the chip tube (55) and the frit ring (56) used in “vacuum exhaustion and filling of a discharge gas to be performed after the sealing treatment”, namely the cleaning gas is introduced via the chip tube (55) and the frit ring (56), it is preferred that the pressure gauge provided at the upstream side of the frit ring (56) is used, and it is more preferred that the pressure gauge provided at the upstream side of the chip tube (55) is used (see FIG. 16). Whereby, it is possible to suitably determine mutual installation conditions of the chip tube, the frit ring and the rear panel from “pressure difference”. The pressure gauge is not particularly restricted as long as it is capable of measuring the pressure difference. Namely, a pressure gauge capable of measuring the pressure difference of about 0.5 to 10 kPa or about 1 to 3 kPa may be used. For example, a pressure gauge used conventionally in the “vacuum exhaustion and filling of the discharge gas to be performed after the sealing treatment” may be used.

### Second Embodiment

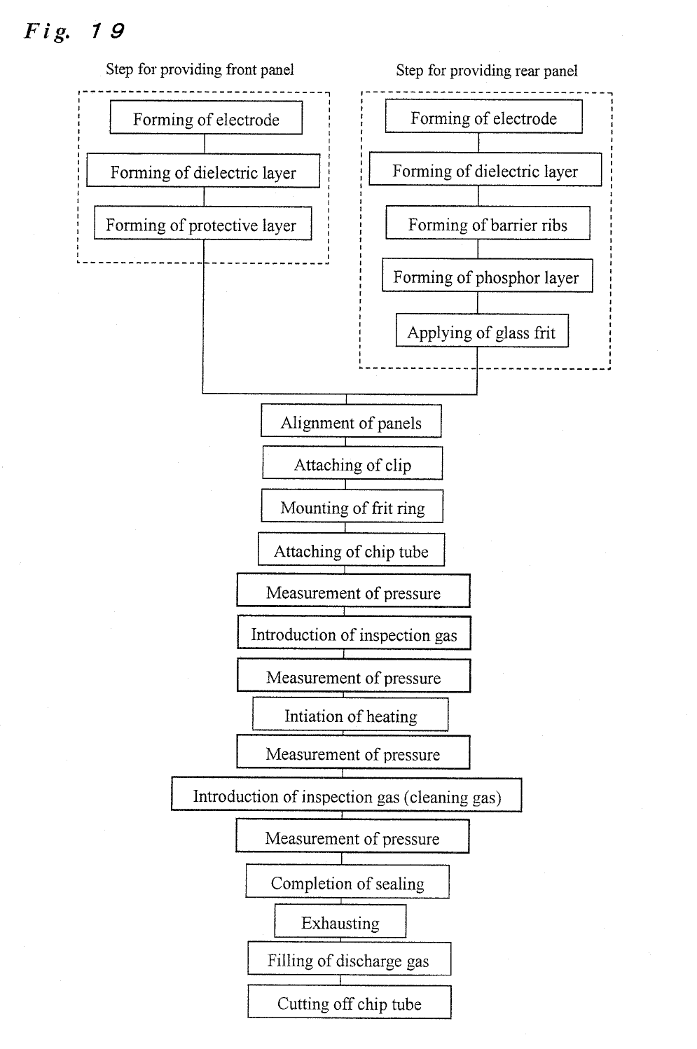

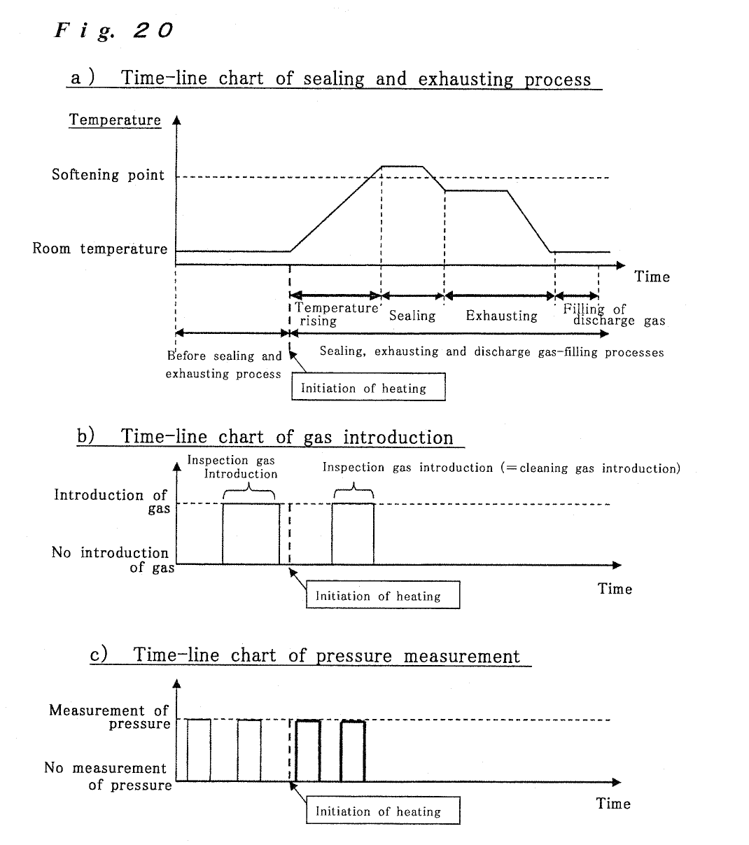

The second embodiment of the present invention will be described wherein an inspection gas is introduced prior to the heat treatment in the step (iv), and thereby a difference in pressure between before and after the introduction of the inspection gas is determined, and also an inspection gas is introduced even after the heat treatment, and thereby a difference in pressure between before and after the introduction of the inspection gas is determined. A diagram for explaining about the second embodiment is shown in FIGS. 19 and 20. FIG. 19 is a flow chart showing a method for producing PDP according to the second embodiment, and FIG. 20 is a process time chart thereof.

In the second embodiment, similarly to the first embodiment, the inspection gas is introduced into the panels via the chip tube and the frit ring used in the “vacuum exhaustion and filling of discharge gas to be performed after the sealing treatment”. However, according to the second embodiment, the introduction of the inspection gas is performed not only before the heat treatment, but also after the heat treatment (see FIGS. 19 and 20). In other words, the inspection gas is additionally introduced even after the heat treatment, and thereby a difference in pressure between before and after such gas introduction is measured wherein the measured value is compared with “threshold value” or “value of a control criterion” set in advance. Whereby, similar to the case of the gas introduction before the heat treatment, it is rated “Good” when the difference in pressure is the threshold value or more, whereas it is rated “Poor” when the difference in pressure is less than the threshold value (see FIG. 17).

When it was rated “Poor” upon the gas introduction after the heat treatment, it is possible to avoid an adverse influence on other panels by stopping the introduction of the gas into the defective panels by operating a valve or the like of the facilities. For example, in a butch furnace for simultaneously treating a plurality of panels and a multistage furnace used for mass production, the assembling or mounting failure of the chip tube and frit ring as well as the adhesion of foreign matters and dusts to the mounting portion thereof may arise in only some panels. In that case, the leakage may arise upon the gas flowing after the initiation of the heat treatment in the sealing and exhausting process, and thereby the flow rate of the gas introduced into other panels may vary. Such a situation is assumed in a common production of PDP. However, in the present invention, since it is possible to block a particular valve of the gas piping connected to the relevant defective panel among valves provided thereof, a desired flow rate of the introduced gas into the other panels can be ensured (by the way, in such a case, there may arise a necessity to adjust the total flow rate to allow the gas to flow to a plurality of panels which is continuously treated as a good quality product for the purpose of averaging the flow rate). According to the second embodiment, it is possible to quickly perform production planning or to cope after completion of the process treatment by finding “Poor” in the process treatment. Particularly in the heating process having a high temperature (e.g. the sealing and exhausting process), such a technique capable of determining a treatment situation during the process can be extremely effective.

The flow rate of the inspection gas to be introduced after the heat treatment and the threshold value for judging “Good”/“Poor” may be the same as in the case of introducing before the heat treatment. However they may be appropriately changed, if necessary. The inspection gas to be introduced after the heat treatment is particularly preferably a cleaning gas. When it is rated “Good” in the gas introduction after the heat treatment, the gas introduction can be continuously performed. In other words, when the inspection gas to be introduced after the heat treatment is a cleaning gas, it is possible to perform “determination of pressure difference” and “cleaning process” substantially simultaneously.

### Third Embodiment

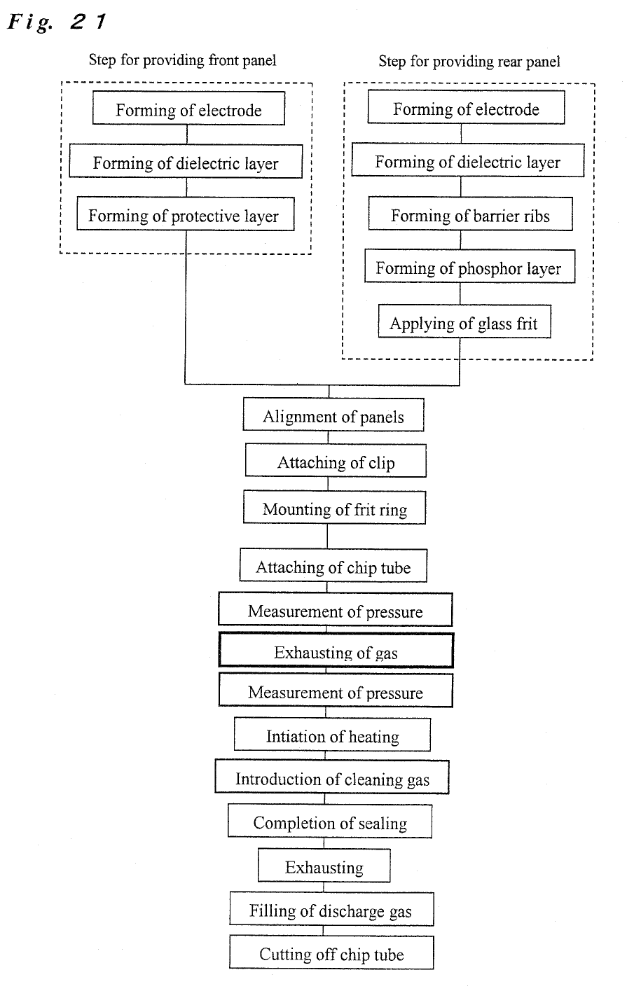

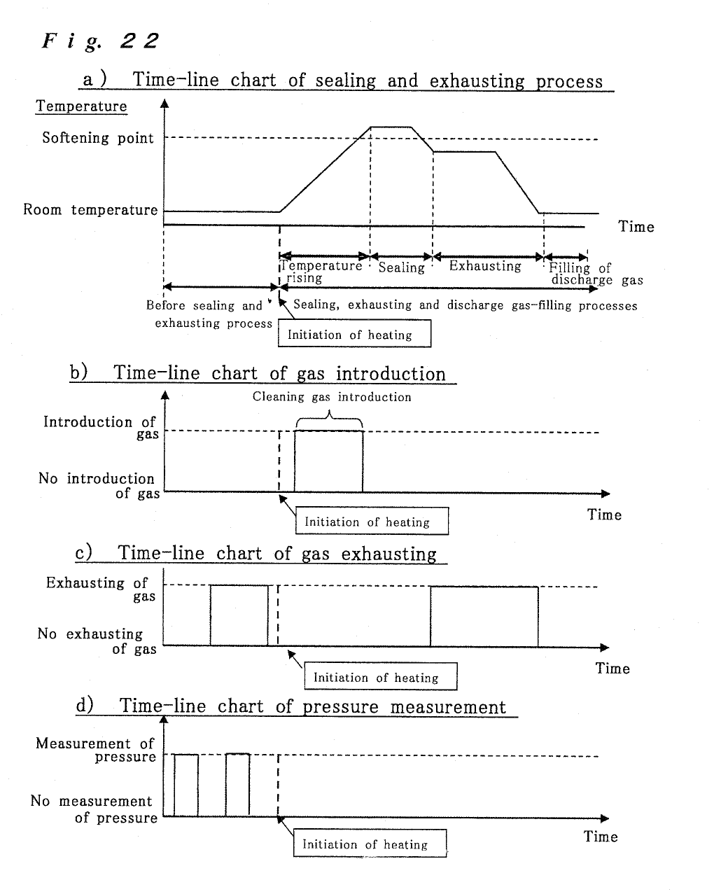

The third embodiment of the present invention will be described wherein a gas is exhausted from inside the panels prior to the heat treatment in the step (iv) panel, and thereby a difference in pressure between before and after the exhausting of the gas is determined. A diagram for explaining about the third embodiment is shown in FIGS. 21 and 22. FIG. 21 is a flow chart showing a method for producing PDP according to the third embodiment, and FIG. 22 is a process time chart thereof.

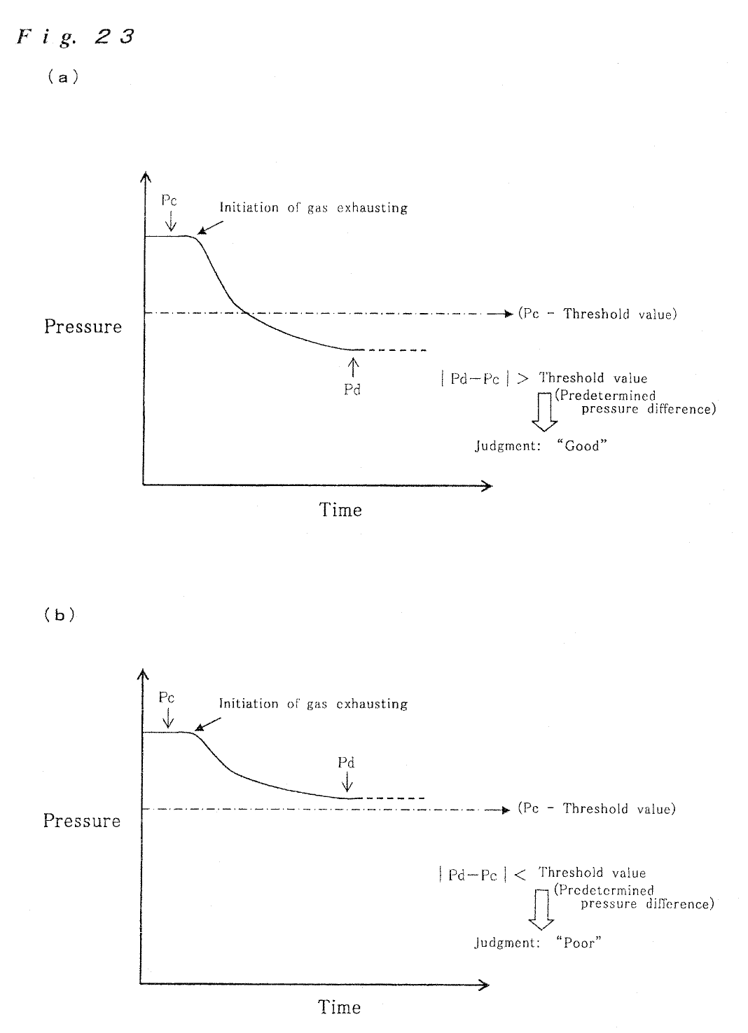

According to the third embodiment, “gas exhaustion” is performed, not “gas introduction” of the first embodiment. In other words, in the third embodiment, a gas is exhausted from inside the panels via a chip tube and frit ring used in “vacuum exhaustion and filling of a discharge gas to be performed after the sealing treatment”. Namely, the evacuation is carried out, and thereby a difference in pressure between before and after the evacuation (i.e. gas exhaustion) is determined. Then, the “difference in pressure” is compared with a “threshold value” or “value of a control criterion” set in advance. Whereby, similar to the case of “gas introduction”, it is rated “Good” when the difference in pressure is the threshold value or more, in which case the cleaning process (and a sealing process) is initiated. On the other hand, it is rated “Poor” when the difference in pressure is less than the threshold value, in which case the assembled, connected or mounted state of the gas exhaustion line, the alignment of the panels and the like are readjusted (see FIG. 23).

Specifically, when the pressure difference is less than the threshold value, “mounted state of the chip tube and the frit ring”, “positional relationship between the chip tube and the aligned panels” and/or “mounted state of the clip for fixing the chip tube and the frit ring to the panel” are readjusted, or “adhesion of foreign matters and dusts to the mounted site” are removed, similarly to the case of “gas introduction”. In that case, a reassembling may be performed by replacement of the parts, the clip and the like, or by replacement of the front and rear panels. When the pressure difference does not still reach the threshold value even after such reassembling is performed, the production process concerning the panels with a possibility of failure may be stopped. Thus, the present invention can ensure an accurate introduction of the cleaning gas into the panels after the heat treatment thereof, thus making it possible to effectively remove the impurity gas, which leads to an achievement of a stable production of the PDP with satisfactory performances.

### Fourth Embodiment

The fourth embodiment will be described wherein a gas piping (111) used for the introduction of the discharge gas is used to perform the introduction of the inspection gas. In FIG. 24, the fourth embodiment is plainly shown.

In a common production of the PDP, a discharge gas is introduced at a predetermined pressure around a final step of the sealing and exhausting process, and then the final sealing is performed by cutting off the chip tube after melting process. Therefore, the PDP production facilities generally have a piping (111) or pressure gauge (105′) for introducing the discharge gas. According to the fourth embodiment, the piping (111) or pressure gauge (105′) for introducing the discharge gas is used as an introduction line of the inspection gas. In a case where the cleaning gas is used as the inspection gas, independency of the inspection gas and the discharge gas is ensured by a valve or the like at the primary side serving as a supplier at the upstream side, or at the gas container side. Whereby, the constitution of process facilities per se becomes simple, and thereby facility costs can be reduced.

### Fifth Embodiment

The fifth embodiment will be described wherein an exhausting piping (112) used in the vacuum exhaustion of the interior of the panels after the sealing treatment is used for the introduction of the inspection gas. In FIG. 25, the fifth embodiment is plainly shown.

As for a common production of the PDP, the melting of the sealing member and the subsequent solidification thereof is performed in the sealing and exhausting process, followed by performing the exhaustion to evacuate the interior of the panels. Therefore, the PDP production facilities generally have a piping (112) and a pressure gauge (105′) for vacuum exhaustion. According to the fifth embodiment, the exhausting piping (112) and pressure gauge (105′) for vacuum exhaustion are used as an introduction line of the inspection gas. In a case where the cleaning gas is used as the inspection gas, independency of the inspection gas line and evacuation line is ensured by a valve or the like at the primary side serving as a supplier at the upstream side, or at the gas container side. Whereby, the constitution of process facilities per se becomes simple, and thereby facility costs can be reduced.

Although a few embodiments of the present invention have been hereinbefore described, the present invention is not limited to these embodiments. It will be readily appreciated by those skilled in the art that various modifications are possible without departing from the scope of the present invention. For example, the following modifications are possible:

The present invention has been hereinabove explained mainly on the assumption of the embodiment wherein the mounted or connected state of the gas introduction line and the assembled state of it with the opposed front and rear panels are recognized by determining a difference in pressure between before and after the introduction of the inspection gas (for example, pressure difference “Pb−Pa” wherein Pa is pressure before gas introduction and Pb is after the introduction of the gas, but the present invention is not necessarily limited to such embodiment. For example, the assembled state or the mounted state may be determined, using, as an indicator, a derivative of a change in pressure until reaching a peak pressure upon the introduction of the inspection gas.

The present invention has been hereinabove explained mainly on the assumption of the embodiment wherein the chip tube and the frit ring constitute a different member with respect to the gas introduction line, but the present invention is not necessarily limited to such embodiment. For example, a member in which a chip tube and a frit ring are integrated in advance may be used in the gas introduction line.

The present invention has been hereinabove explained mainly on the assumption of an embodiment wherein, for example, at least one kind of gas selected from the group consisting of a nitrogen gas, a noble gas and a dry air is used as the cleaning gas or the inspection gas, but the present invention is not necessarily limited to such embodiment. The cleaning gas and the inspection gas may be used by selecting conditions suited for the protective layer material and the sealing and exhausting process.

The present invention has been hereinabove described mainly on the assumption of the embodiment wherein the protective layer is made of a metal oxide consisting of at least two oxides selected from among magnesium oxide, calcium oxide, strontium oxide and barium oxide, but the present invention is not necessarily limited to such embodiment. For example, the protective layer may be those disclosed in Japanese Unexamined Patent Kokai Publication No. 2004-47193 (for example, the protective layer may be formed from lanthanide oxide such as lanthanum oxide or cerium oxide). Even in such a case, the effects of the invention are the same.

Describing in view of the fact that the effects of the present invention are the same, the present invention can also be suitably applied to a method for producing PDP in which a protective layer is formed by an electron beam vapor deposition process, or by applying a paste containing PDP fine metal oxide particles, and drying the paste.

The dielectric layer formed on the front panel may also have two-layered structure composed of a first dielectric layer and a second dielectric layer. In this case, it is preferable that the first dielectric layer is formed from a dielectric material that contains 20 to 40% by weight of bismuth oxide (Bi₂O₃), 0.5 to 12% by weight of at least one kind selected from among calcium oxide (CaO), strontium oxide (SrO) and barium oxide (BaO) and 0.1 to 7% by weight of at least one kind selected from among molybdenum oxide (MoO₃), tungsten oxide (WO₃), cerium oxide (CeO₂) and manganese dioxide (MnO₂). Instead of molybdenum oxide (MoO₃), tungsten oxide (WO₃), cerium oxide (CeO₂) and manganese dioxide (MnO₂), 0.1 to 7% by weight of at least one kind selected from among copper oxide (CuO), chromium oxide (Cr₂O₃), cobalt oxide (Co₂O₃), vanadium oxide (V₂O₇) and antimony oxide (Sb₂O₃) may be contained. Also in addition to the components described above, such a composition that does not contain the element lead may be employed as 0 to 40% by weight of zinc oxide (ZnO), 0 to 35% by weight of boron oxide (B₂O₃), 0 to 15% by weight of silicon oxide (SiO₂) and 0 to 10% by weight of aluminum oxide (Al₂O₃). A paste material for the first dielectric layer having such a composition as described above is applied to the front-sided glass substrate by a die coating process or screen printing process so as to cover the display electrodes and then is dried, followed by firing thereof at a temperature of from 575° C. to 590° C. that is a little higher than the softening point of the dielectric material, and thereby the first dielectric layer can be formed.

The second dielectric layer is preferably formed from a material that contains 11 to 20% by weight of bismuth oxide (Bi₂O₃), 1.6 to 21% by weight of at least one kind selected from among calcium oxide (CaO), strontium oxide (SrO) and barium oxide (BaO) and 0.1 to 7% by weight of at least one kind selected from among molybdenum oxide (MoO₃), tungsten oxide (WO₃) and cerium oxide (CeO₂). Instead of molybdenum oxide (MoO₃), tungsten oxide (WO₃) and cerium oxide (CeO₂), 0.1 to 7% by weight of at least one kind selected from among copper oxide (CuO), chromium oxide (Cr₂O₃), cobalt oxide (Co₂O₃), vanadium oxide (V₂O₇), antimony oxide (Sb₂O₃) and manganese dioxide (MnO₂) may be contained. Also in addition to the components described above, such a composition that does not contain the element lead may be employed as 0 to 40% by weight of zinc oxide (ZnO), 0 to 35% by weight of boron oxide (B₂O₃), 0 to 15% by weight of silicon oxide (SiO₂) and 0 to 10% by weight of aluminum oxide (Al₂O₃). A paste for the second dielectric layer having such a composition as described above is applied to the first dielectric layer by the screen printing process or die coating process and then is dried, followed by firing thereof at a temperature of from 550° C. to 590° C. that is a little higher than the softening point of the dielectric material, and thereby the second dielectric layer can be formed. The PDP thus produced is less likely to cause a discoloration phenomenon (yellowing) of the front glass substrate even when silver (Ag) is used in the display electrodes. Moreover, no gas bubble is generated in the dielectric layer, so that a dielectric layer having high dielectric voltage resistance can be realized.

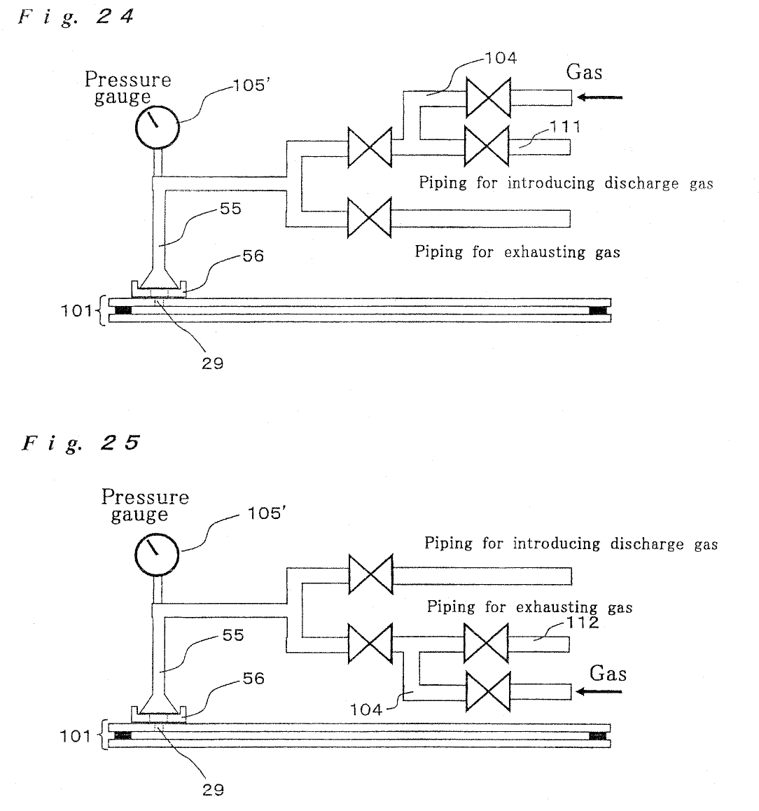

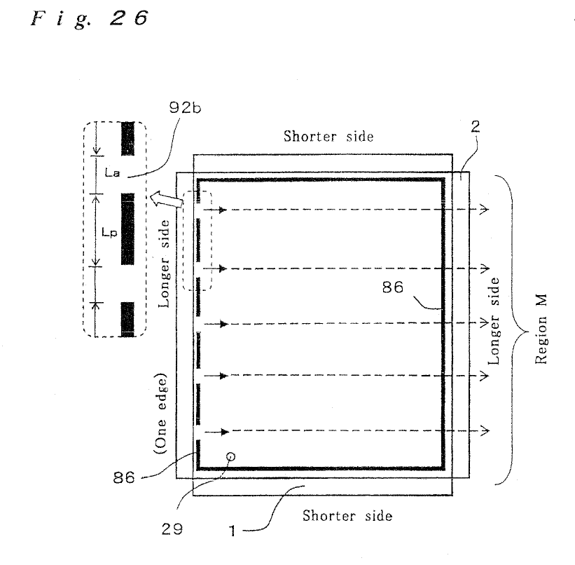

The cleaning gas in the step (iv) may be introduced from a direction lateral to the opposed front and rear panels (see FIG. 26). Namely the cleaning gas may be supplied into a space formed between the opposed front and rear panels in a lateral direction through a side of the opposed front and rear panels. In such case, an annular glass frit sealing member (86) may be provided with a plurality of inlet grooves (92b) as shown in FIG. 26. A nozzle for supplying or blowing the gas in the lateral direction may be provided with the pressure gauge, and thereby the pressure difference between before and after the gas introduction can be measured. The inlet grooves (92b) can be formed by partially removing or cutting off the applied glass frit material. Alternatively, the inlet grooves can be formed by intermittently applying a glass frit material. The length La (see FIG. 26) of the inlet grooves (92b) is, for example, roughly from 0.1 to 5 mm. The pitch Lp (see FIG. 26) of the inlet grooves can vary depending on the substrate size or the other factors, but is for example roughly from 50 to 500 mm. Similar to the case of the above supply opening, it is preferred that a plurality of the inlet grooves are provided along the longer side of the edge of the front panel (1) or the rear panel (2). In the case of the inlet grooves being used, the inlet grooves are gradually clogged due to the softening and melting of the annular glass frit sealing member in the sealing treatment. As a result, the cleaning gas supplied finally cannot flow into the space between the front and rear panels due to the presence of the melted glass frit, and thereby automatically or spontaneously ceasing the cleaning gas supply into the space formed between the front and rear panels. This results in an achievement of minimum cleaning gas consumption.

### Examples

A 42-inch test panel was fabricated. Using this panel, an operation test was carried out according to the first embodiment to confirm the effects of the present invention.

### (Fabrication of Panel)

A 1.8 mm-thick glass substrate was used as each of the front-sided and rear-sided substrates of the 42-inch test panel. As for the rear panel, a panel for single-scan specification was used. The barrier ribs with their height of 100 μm were formed in the rear panel. An annular glass frit sealing member formed in the rear panel had a width (coating width) of 4 mm and a height of 400 μm. As for the opposed front and rear panels, the distance (gap) between the rear panel and the front panel was 400 μm corresponding to a height of the annular glass frit sealing member. The distance (gap) between “top of the barrier ribs of the rear panel” and “surface of the protective layer of the front panel” was 300 μm. Upon the introduction of an inspection gas, the chip tube (55), the frit ring (56), the introduction piping (104) and the pressure gauge (105) as shown in FIG. 16 were used.

### (Validation Test of Pressure Difference by Introduction of Inspection Gas)

Under the following conditions, the inspection gas was introduced and then “difference in pressure between before and after the introduction” was measured:

Inspection gas: nitrogen gas with a purity of 99.999% or more (=cleaning gas)

Introduction piping (104)

Material: Stainless steel

Size: ¼ inch

Chip tube (55)

Material: glass frit material for sealing

Inner diameter of columnar-shaped portion: about 3 mm

Full length: about 70 mm

Frit ring (56)

Material: glass frit material for sealing

Inner diameter: about 10 mm

Full length: about 2 mm

Diameter of through hole (29) of rear panel: about 2 mm

Flow rate of inspection gas: about 5 SLM

Pressure gauge (105): Diaphragm-type pressure gauge manufactured by MKS Corporation

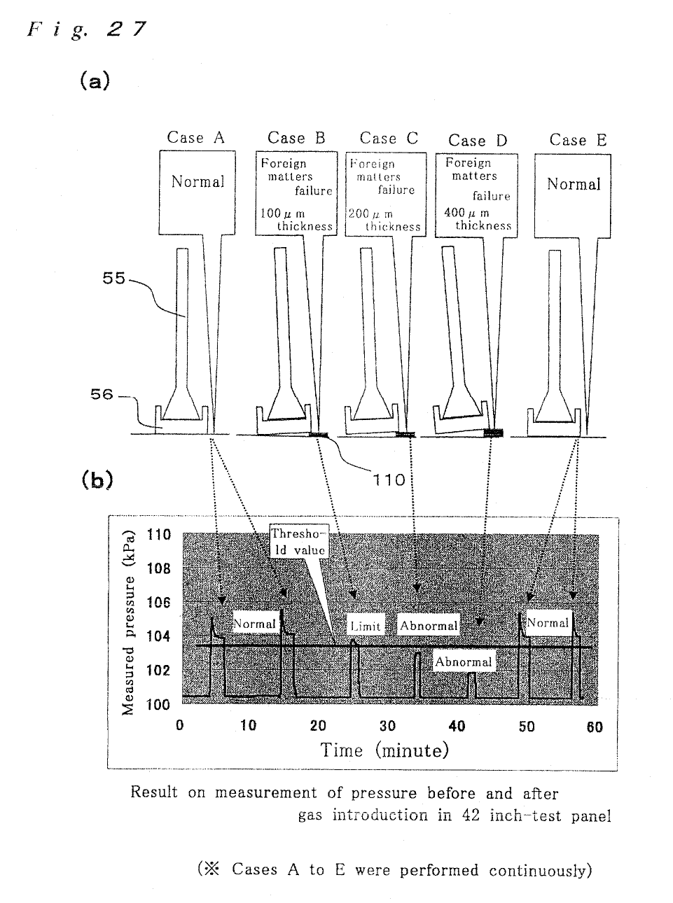

For the validation test of pressure difference by introduction of inspection gas, a reproduction test was performed with respect to the cases where foreign matters (dusts) exist in a space between the frit ring (56) and the aligned panels (101) (i.e., there existed a gap between the frit ring and the aligned panels) in which the chip tube (55) and the frit ring (56) are mounted in the aligned panel (101) using a clip. Specifically, as shown in FIG. 27(a), the pressure difference between before and after the gas introduction was obtained under conditions such as a normal condition in which foreign matters (110) did not exist (case A), a condition in which the size of foreign matters was varied to the following three kinds, e.g., 100 μm (case B), 200 μm (case C) and 300 μm (case D), and finally a normal condition (case E). The pressure (value of the pressure gauge) before the gas introduction was about 100.5 kPa. Waiting for about 1 minute after the initiation of the gas introduction under “normal condition”, the pressure was finally stabilized to reach about 103.5 kPa. Therefore, the threshold value was determined as 3.0 kPa (=103.5-100.5) based on the value of the pressure gauge. Accordingly, it was rated “Good” in the case of the pressure difference between before and after the gas introduction being 3.0 kPa or more, whereas it was rated “Poor” in the case of the pressure difference between before and after the gas introduction being less than 3.0 kPa. As to the pressure value after the gas introduction, the gas generally does not spread through inside the panels immediately after the gas introduction depending on a design specification of the panels (for example, a structure of an internal element pattern thereof), a piping constitution of facilities and the like, and thereby the pressure is gradually stabilized after a peak of an increase in pressure at the initial stage of gas introduction. Therefore, the measurement after the gas introduction was carried out at the point in time when the stability of the pressure was confirmed after the gas introduction.

### (Results)

The results of cases A to E are shown in FIG. 27(b):

Case A: The measured pressure before gas introduction was 100.5 kPa, whereas the measured pressure after gas introduction was 103.8 kPa for the first time, and 104.1 kPa for the second time. Consequently, the pressure difference between before and after the gas introduction was more than 3.0 kPa of the threshold value.

Case B: In the case of the foreign matters (110) exiting to form the gap of about 100 μm between the frit ring (56) and the panel, the pressure difference between before and after the gas introduction was 3.0 kPa of the threshold value. It is difficult for such a condition to sufficiently guarantee the quality of the product per se and the production process in mass production. Therefore, it was rated “threshold” this time.

Case C: In the case of the foreign matters (110) exiting to form the gap of about 200 μm between the frit ring (56) and the panel, the pressure difference between before and after the gas introduction was less than 3.0 kPa of the threshold value. As a matter of course, if such a thing should happen upon mass production, it is rated “Poor”.

Case D: In the case of the foreign matters (110) exiting to form the gap of about 400 μm between the frit ring (56) and the panel, the pressure difference between before and after the gas introduction was less than 3.0 kPa of the threshold value. As a matter of course, if such a thing should happen upon mass production, it is rated “Poor”.

Case E: Finally, for the confirmation of reproducibility, the pressure difference was again measured under the same condition (normal condition) as that of the first case A. As a result, the measured pressure after gas introduction was 104.0 kPa for the first time, and 104.0 kPa for the second time. Consequently, the pressure difference between before and after the gas introduction was more than 3.0 kPa of the threshold value.

In the cases A to E of the validation tests, an operation of removing and attaching the clip for fixing the chip tube and the frit ring, or an operation of reassembling the chip tube and frit ring were performed many times. It has been found that it is possible to finally achieve the desired “assembled state”, “connected state” and “mounted state” of the parts and the panels associated with the PDP production even after such an operation is performed. Therefore, it will be understood that the present invention enables a control of product quality, thus leading to a guarantee of the product quality of the PDP.

### INDUSTRIAL APPLICABILITY

According to the present invention, it is possible to realize PDP with display performance of higher brightness, and a lower voltage driving. In other words, a gas (e.g., moisture, carbon dioxide) which can cause denaturation and deterioration of the surface of the protective layer is scarcely contained inside the obtained PDP. As a result, even if PDP is operated over a long period of time, the problem such as a denaturation of the protective layer or phosphor layer does not arise, the denaturation being attributable to the release of the impurity gas such as H₂O or CO₂ into the discharge space. This means that the PDP obtained by the method of the present invention is less likely to cause a change in brightness while maintaining a low discharge voltage, and thus it has a satisfactory service life of the panel.

The PDP obtained by the method of the present is not only suitable for household use and commercial use, but also suitable for use in other various kinds of display since it has a satisfactory service life of the panel.

### CROSS REFERENCE TO RELATED PATENT APPLICATION

The disclosure of Japanese Patent Application No. 2010-004853 filed Jan. 13, 2010 including specification, drawings and claims is incorporated herein by reference in its entirety.

What is claimed is:

1. A method for producing a plasma display panel, the method comprising:
(i) providing a front panel and a rear panel, the front panel being a panel wherein an electrode A, a dielectric layer A and a protective layer are formed on a substrate A, and the rear panel being a panel wherein an electrode B, a dielectric layer B, a barrier rib and a phosphor layer are formed on a substrate B;
(ii) supplying a glass frit material onto a peripheral region of the substrate A or B to form a glass frit sealing member;
(iii) opposing the front and rear panels with each other such that the glass frit sealing member is interposed therebetween; and
(iv) heating the opposed front and rear panels to reach a softening point of the glass frit sealing member or a higher temperature than the softening point and thereby causing the front and rear panels to be sealed, while supplying a cleaning gas into a space formed between the opposed front and rear panels until the point in time when the softening point of the glass frit sealing member is reached from an initiation of the heating of the panels, wherein, prior to the heating of the step (iv), a gas is introduced into the space formed between the opposed front and rear panels, or a gas is exhausted from the space formed between the opposed front and rear panels, and thereby a difference in pressure between before and after the gas introduction or the gas exhaustion is determined.

2. The method according to claim 1, wherein a pressure gauge provided in a gas introduction line is used to determine the difference in pressure between before and after the gas introduction.

3. The method according to claim 2, wherein a line for introducing a discharge gas for the plasma display panel is used as the gas introduction line.

4. The method according to claim 1, wherein a gas is introduced into the space formed between the opposed front and rear panels until the point in time when the softening point of the glass frit sealing member is reached from the initiation of the heating of the step (iv), and thereby the difference in pressure between before and after such gas introduction is also determined.

5. The method according to claim 1 wherein, in the step (i), the protective layer is made from a metal oxide comprising at least two oxides selected from among magnesium oxide, calcium oxide, strontium oxide and barium oxide, the metal oxide having a peak diffraction angle between the minimum diffraction angle and the maximum diffraction angle which are selected among the diffraction angles given by respective ones of at least two oxides constituting the metal oxide with respect to a specific orientation plane of X-ray diffraction analysis of the metal oxide.

6. The method according to claim 1, wherein the cleaning gas is used as the gas for determining the difference in pressure between before and after the gas introduction.
